(19) United States
(12) Patent Application Publication
(10) Pub. No.: US 2012/0107144 A1
(43) Pub. Date: May 3, 2012

(54) VARIABLE BORE CONVERTIBLE COMPRESSOR CYLINDER

(76) Inventor: Eric G. Keifer, Zanesville, OH (US)

(21) Appl. No.: 13/283,880

(22) Filed: Oct. 28, 2011

Related U.S. Application Data
(60) Provisional application No. 61/408,254, filed on Oct. 29, 2010.

(51) Int. Cl. F04B 53/10; B23P 11/00; F04B 49/22

(52) U.S. Cl. 417/53; 417/536; 29/888.02

(57) ABSTRACT

A variable bore reciprocating compressor cylinder, with a family of removable liners of various diameters that can accommodate significant changes in bore diameters without significant increases in fixed clearance volume. In one embodiment of the invention, valves are added or subtracted as required in conjunction with optimizing the flow area of the liner and head ports to minimize clearance volume and to keep overall flow losses within acceptable values. In another embodiment of the invention, smaller valves and valve extension insert/adapters are incorporated to further extend the practical operating range with smaller bore diameters.

### CROSS-REFERENCE TO RELATED APPLICATIONS

This application claims priority to U.S. Provisional Application No. 61/408,254, filed Oct. 29, 2010, the disclosure of which is incorporated herein by reference in its entirety.

### FIELD OF THE INVENTION

The present invention relates in general to double-acting reciprocating compressor cylinders used for wellhead, gas gathering, and other applications in the compression industry for natural gas and other gases, and in particular to reciprocating compressor cylinders having a liner to adjust the bore diameter of the cylinder.

### BACKGROUND OF THE INVENTION

Reciprocating compressors are positive displacement machines wherein a reciprocating piston translates within a cylindrical volume. They are commonly used for a wide range of applications that include, but are not limited to, the pressurization and transport of media such as air, natural gas, and other compressible gases and fluids through pipelines and other similar systems that are used for gas transmission, distribution, injection, storage, processing, refining, oil production, refrigeration, air separation, utility, and other industrial and commercial processes.

Transport of gases and compressible fluids through pipelines is typically accomplished by increasing the pressure on the fluid in the pipeline. This is typically accomplished by compressor(s) connected to the system. The capacity of a compressor cylinder is a function of the piston displacement, and depends on the volume swept by the piston inside the cylinder (i.e. the area of the cylinder bore diameter multiplied by the length of the piston stroke) per unit time.

Conventional reciprocating compressors, particularly those used for transporting natural gas and other compressible fluids through pipelines, typically use horizontally reciprocating, double-acting cylinder(s) to compress the transported medium. During the intake or suction stroke, gas is drawn from the transmission lines into the compressor cylinder's compression chamber through poppet or plate valves. Similarly, during the exhaust, or discharge, stroke, gas at a higher pressure is discharged from the compressor cylinder's compression chamber through poppet or plate valves to the transmission lines.

Compressors of this general type are widely used, and have gained widespread acceptance. Some reciprocating compressor cylinders are fitted with a liner in the cylinder bore (lined or sleeved), whereas some cylinder bores are unlined. Unlined cylinder bores are limited in application flexibility because the cylinder bore diameter is fixed and cannot be changed to vary the capacity. Lined cylinders offer more flexibility, because the bore diameter can be reduced by replacing the original liner (or sleeve) with one having a smaller bore diameter, if required for a particular application. Also, the use of a replaceable liner in the cylinder bore provides a means of restoring the cylinder's running bore if wear or damage exceeds acceptable limits.

Clearance volume (or, fixed clearance volume) of a compressor cylinder includes the volume contributed by the valves, head ports, liner ports, piston end clearance, piston to liner clearance, etc. Some minimum clearance volume is necessary to prevent piston/head interference during operation. Additional clearance volume has the effect of reducing compressor capacity. Capacity reduction is amplified as the compression ratio (ratio of the absolute discharge pressure to the absolute suction pressure) increases. For this reason, it is desirable for cylinders that are used in medium to high pressure ratio applications to have minimal clearance volume.

For a given cylinder body, the present art for lined compressor cylinders is limited by how small the bore diameter can be reduced with a liner without rendering the cylinder ineffective. Fixed clearance volume is commonly expressed as a percentage (i.e. the ratio of the fixed clearance volume to piston swept volume×100). Reducing the bore diameter of the liner increases the clearance volume contributed by the liner ports, because the radial thickness of the liner increases while the port area remains constant. Reducing the bore diameter reduces the swept volume. As a result of decreasing the bore diameter, the decrease in swept volume and the increase in added clearance from the liner ports will dramatically increase the percentage of fixed clearance volume in the cylinder. As the bore diameter is decreased, a limit is reached where the fixed clearance percentage eventually becomes too high and it renders the operation of the cylinder unsuitable. When this limit is reached, a smaller class of cylinder body must be selected with a suitable bore diameter and a lower clearance volume to suit the application.

U.S. Pat. No. 3,215,086 to Shively and U.S. Pat. No. 4,360,319 to Paget teach variable bore compressor cylinders that address the problem of increasing clearance volume as the bore diameter is reduced. The Shively patent is a “valve in head” design that addresses the clearance volume issue with a special conical piston design and a liquid cooled liner. The Paget patent is also a “valve in head” design with a liquid cooled liner that addresses the clearance volume issue by eliminating features (ports in the valve) and components (sealing plates in the valve) from the valve assemblies to reduce the clearance volume contribution from the valves. The Paget design is based on the fact that decreased bore diameter leads to decreased mass flow and less valve flow area is required for the smaller bore diameter.

While these prior art devices served the purpose of reducing clearance volume as the liner bore diameter is reduced, there remains a need for a method of extending the bore ranges beyond the capabilities of these prior inventions. The present invention extends the range significantly further than the previous inventions so that one (1) cylinder body can eliminate eight (8) or more of the traditional cylinder bodies typically required to support a range of applications, while still maintaining acceptable clearance volume. For example, FIG. 8 herein comparatively illustrates the present invention's improvement in clearance volume control compared to cylinders manufactured according to prior art. The present invention also provides for quick, in situ conversions of the cylinder bore diameter for changing field conditions.

### SUMMARY OF THE INVENTION

The present invention extends the range of the bore diameters for lined, reciprocating compressor cylinders significantly beyond what is currently practical for conventional reciprocating compressor cylinders. While the invention typically relates to the “valve-in-body” design described below, the invention can also include a “valve-in-head” design.

A first aspect of the invention provides a reciprocating compressor cylinder for admitting gas at a suction inlet and discharging gas at increased pressure from a discharge outlet, the compressor cylinder comprising a body, a liner, at least one cylinder head, head end port rings or head end port inserts, crank end port rings or crank end port inserts, suction valve(s), suction valve extension insert/adapter(s), suction valve retainer(s), discharge valve(s), discharge valve extension insert/adapter(s), and discharge valve retainer(s), wherein said liner, head end port rings or head end port inserts, crank end port rings or crank end port inserts, valves, valve extension insert/adapter(s) and valve retainers can be installed or removed from the compressor cylinder either as separate components or as intact sub-assemblies.

The compressor can be reconfigured with larger or smaller bores in the field as the compression requirements change by removing, usually, but not necessarily, in the following order, the head end cylinder head, the piston assembly, the suction valve retainer(s), the suction valve(s), the suction valve extension insert/adapter(s), the discharge valve retainer(s), the discharge valves(s), the discharge valve extension insert/adapter(s), and the cylinder liner from the cylinder assembly, thereafter removing the current crank end port ring or crank end port inserts and replacing it/them with new crank end port ring or crank end port inserts possessing a different port configuration, thereafter removing the current head end port ring or head end port inserts and replacing it/them with new head end port ring or head end port inserts possessing a different port configuration, thereafter installing a new cylinder liner, a new piston assembly having a diameter that matches the new cylinder liner, suction valve extension insert/adapter(s), suction valve(s), suction valve retainer(s), discharge valve extension insert/adapter(s), discharge valves(s), and, when appropriate, suction valve plug(s) and/or discharge valve plug(s) instead of one or more of the suction and discharge valves, respectively, and valve retainers in the cylinder assembly as required for the application. The compressor can include, but is not limited to, discharge and/or suction valve porting that consists of a semicircular port(s) that is merged with and adjacent to a rectangular port(s) machined in the cylinder liner.

A second aspect of the invention provides a method of quickly and easily removing a valve, valve extension insert/adapter and valve retainer of a compressor cylinder assembly from a cylinder body valve pocket as an entire unit or cartridge in a single motion.

The method typically involves changing the cylinder liner bore diameter; the number, size and/or position of the suction and discharge valves; and the number, size and/or geometry of the gas flow passages between the cylinder bore and each valve, thereby allowing the user to change the cylinder bore liner diameter while simultaneously minimizing the clearance volume and providing for acceptable flow losses as required for a particular application.

Some of the valves, liner ports, and head ports can be reduced in size, changed in geometry, or eliminated as the bore diameter decreases to reduce clearance volume while simultaneously providing for acceptable flow losses.

The nature and advantages of the present invention will be more fully appreciated from the following drawings, detailed description and claims.

### BRIEF DESCRIPTION OF THE DRAWINGS

The accompanying drawings illustrate the embodiments of the present invention and together, with the general description of the invention given above and the detailed description given below, serve to explain the invention.

FIG. 1A is a cross-sectional view of a conventional, double-acting reciprocating compressor cylinder as is known in the prior art.

FIG. 1B is a section view of the cylinder of FIG. 1 taken through the valve pockets at the head end of the cylinder.

FIG. 2A is an external side view of the present invention showing the location of the section for FIG. 2B.

FIG. 2B is a transverse section view of a first embodiment of the invention taken through the valve pockets at the head end of the cylinder and illustrates the location of the valves and the valve plugs.

FIG. 3A is an external end view of the present invention showing the location of the sections for FIGS. 3B and 4.

FIG. 3B is a section view of the embodiment of FIGS. 2A and 2B taken through the cylinder longitudinal axis through the valve pockets containing the suction and discharge valves.

FIG. 4 is a section view of the embodiment of FIGS. 2A and 2B taken through the cylinder longitudinal axis through valve pockets fitted with the plugs in unused suction and discharge valve pockets.

FIG. 5A is an external side view of a second embodiment of the present invention showing the location of the section for FIG. 5B.

FIG. 5B is a transverse section view of a second embodiment of the invention taken through the valve pockets at the head end of the cylinder and illustrates the location of the valves with valve insert/adapters and the valve plugs.

FIG. 6A is an external end view of the present invention showing the location of the sections for FIGS. 6B and 7.

FIG. 6B is a section view of the embodiment of FIGS. 5A and 5B taken through the cylinder longitudinal axis through the valve pockets containing the valve extension insert/adapter(s) and the suction and discharge valves.

FIG. 7 is a section view of the embodiment of FIGS. 5A and 5B taken through the cylinder longitudinal axis through valve pockets fitted with the plugs in unused suction and discharge valve pockets.

FIG. 8 is a graph illustrating clearance volume as a percentage of swept volume versus cylinder bore diameter for one embodiment of the present invention as compared to present technology.

FIG. 9A is a cross-sectional view of valve ports for prior art showing the location of a perspective view of a valve port for FIG. 9B.

FIG. 9B is a perspective view of valve ports for prior art and illustrates the masking of flow area by the piston.

FIG. 10A is a cross-sectional view of the present invention showing the locating of a perspective view of a valve port for FIG. 10B.

FIG. 10B is a perspective view of a valve port for the present invention and illustrates an improved geometry for minimizing volumetric clearance while simultaneously providing effective porting flow area by utilizing discharge porting that consists of a semicircular port(s) that is merged with and adjacent to a rectangular port(s) machined in the cylinder liner, as opposed to a prior art port as illustrated in FIGS. 9A and 9B.

FIG. 11A is a cross-sectional view through valve ports for prior art showing the location of a perspective view of a valve port for FIG. 11B.

FIG. 11B is a perspective view of a valve port for prior art, illustrating the restrictive flow path of the prior art elliptical port.

FIG. 12A is a cross-sectional view through valve ports of the present invention showing the location of a perspective view of a valve port for FIG. 12B

FIG. 12B is a perspective view of a valve port for the present invention, illustrating the flow areas improvement over the prior art elliptical port.

FIG. 13 is a pressure vs. volume graph showing how compression occurs within a cylinder as a four-part cycle that occurs with each advance and retreat of the piston.

### DETAILED DESCRIPTION OF THE INVENTION

A reciprocating compressor consists of one or more cylinders that are typically attached to a compressor frame or crankcase that contains a crankshaft, connecting rod(s), crosshead(s) and other ancillary equipment necessary to impart reciprocating motion to the piston. The compressor frame's crankshaft is typically driven by an electric motor or internal combustion engine, but can also be driven by turbines or other devices.

In general, conventional reciprocating compressor cylinders are categorized as either “valve-in-head” or “valve-in-body” designs. The designation denotes the location of the suction and discharge valve(s) in the reciprocating compressor cylinder assembly. In the case of a “valve-in-head” design, isolated suction and discharge plenums within the cylinder head(s) communicate with isolated suction and discharge plenums, respectively, in the cylinder body. In the case of a “valve-in-body” design, isolated suction and discharge plenums are present only in the cylinder body. Two (2) compression chambers are formed between the inner surfaces of the head(s) and/or the end wall of the cylinder body, the two end faces and part of the outside diameter up to the first sealing rings on each end of the piston, and the cylinder bore on both ends of the cylinder in a double-acting design. The compression chamber nearest to the frame or crankcase and the components related to this compression chamber are designated as “crank end”. The opposing compression chamber farthest from the frame or crankcase, and the components related to the opposing compression chamber are designated as “head end.”

The piston is connected to a piston rod. The piston rod is connected to the components internal to the compressor frame. The frame internal components impart the reciprocating motion to the piston rod and piston as the crankshaft is driven in a rotary motion by a driver or power source. Piston sealing rings seal the pressure between the head end and crank end compression chambers. These seals are interposed between the piston and the cylinder bore. In addition, the piston is commonly supported by rider rings or bands that carry the weight of the piston and prevent it from contacting the cylinder liner surface. In some cases, the piston sealing rings may also be configured to support the piston instead of using separate rider rings.

Piston rod sealing rings seal the pressure in the crank end compression chamber between the piston rod and the packing case to limit the leakage of gas from the cylinder. Suction and discharge check valves are respectively interposed between the compression chambers and the suction and discharge plenums. The suction and discharge check valves control the gas flow direction from the suction plenum to the compression chamber and from the compression chamber to the discharge plenum as the piston reciprocates. The suction and discharge plenums are connected to and communicate with the suction and discharge transmission piping, respectively.

Due to mechanical clearances and the geometry of the various components comprising the compressor cylinder assembly, not all of the gas in the compression chamber can be displaced by the piston when the piston reaches the end of the stroke. When the discharge valve closes at the end of the discharge event, there is still some gas left in the compression chamber. This volume of gas is referred to as the “clearance volume” or the “fixed clearance volume.” Some minimum clearance volume is necessary to prevent piston/head interference. The manipulation of this volume is a major compressor performance parameter and will become evident in the following discussion. Adding clearance volume reduces the compressor capacity by reducing the suction volumetric efficiency; and removing clearance volume increases the compressor capacity by increasing the suction volumetric efficiency. The effect that added clearance volume has on reducing the compressor capacity is amplified when the compression ratio (ratio of the absolute discharge pressure to the absolute suction pressure) increases. For this reason, it is desirable for cylinders that are used in medium to high pressure ratio applications to have minimal clearance volume.

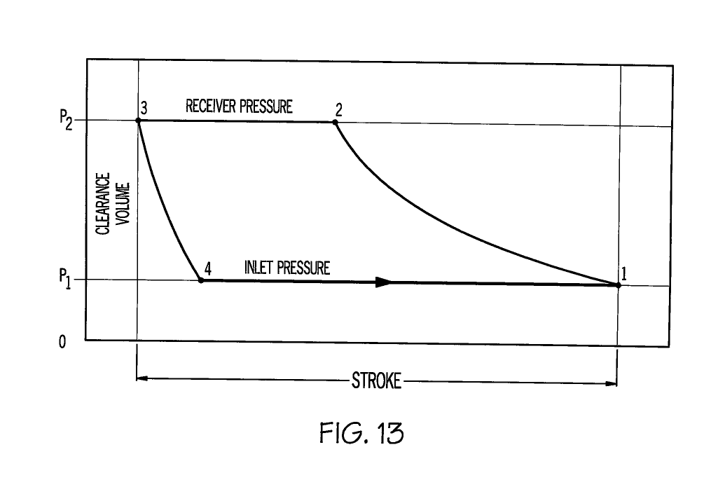

A brief explanation of a few basic thermodynamic principles is helpful to the understanding of the science of reciprocating compressors. Compression occurs within the cylinder as a four-part cycle that occurs with each advance and retreat of the piston (two strokes per cycle). The four parts of the cycle are compression, discharge, expansion and intake (or suction). They are shown graphically with pressure vs. volume plotted in what is known as a P-V diagram shown in FIG. 13.

At the conclusion of a prior cycle, the piston is fully retreated within the cylinder at a first volume, represented by point 1 in FIG. 13, the volume of which is filled with process gas at suction conditions (at a first pressure, P1, and a first temperature), and the suction and discharge valves are all closed which is also termed the compression chamber. This volume is the space within the cylinder between the piston and the cylinder head. As the piston advances toward the head end of the cylinder, the volume of gas within the cylinder is reduced and the gas undergoes isentropic compression. This causes the pressure and temperature of the gas to rise as the piston moves and the volume is decreased until the pressure within the cylinder becomes slightly higher than the pressure of the discharge header, or plenum. This is illustrated along the line between points 1 and 2 of FIG. 13.

At this time, the discharge valve(s) begin to open, noted on the diagram by point 2. With the discharge valves open, pressure remains fixed at P2 for the remainder of the advancing stroke as volume continues to decrease for the discharge portion of the cycle. Gas continues to flow through the discharge valve(s) as the piston progresses to the end of the stroke. This is illustrated along the line between points 2 and 3 of FIG. 13. When the piston reaches the head end of the stroke, the pressure equalizes across the discharge check valve(s), the flow through the valve(s) stops, and the discharge check valve(s) closes. The cycle is now at point 3. The piston comes to a momentary stop at the most advanced position in its travel before reversing direction.

Note that some minimal volume remains in the cylinder. This is the clearance volume discussed above. It is the space containing the gas that remains within the cylinder between the piston and the cylinder head when the piston is at point 3, after the compressed gas is discharged from the cylinder. As the piston reverses direction and begins its return stroke, the gas which remains in the clearance volume expands isentropically to slightly below suction pressure. The temperature and pressure of the gas decrease as the piston moves away from the end of the cylinder, illustrated along the line between points 3 and 4, until the pressure of the gas in the compression chamber is equal to the pressure of the gas in the suction plenum where expansion event ends at point 4.

In the last stage of the cycle, as the piston continues to move towards the crank end, the cylinder pressure falls slightly below P1, and the intake valve(s) opens and a fresh charge of gas at suction conditions is admitted into the cylinder to be compressed. Once again, pressure remains essentially constant as the volume is increased as illustrated along the line between points 4 and 1. The gas continues to flow through the suction check valve(s) as the piston progresses to the end of the stroke. When the piston reaches the other end of the stroke, the pressure equalizes across the suction check valve(s), the flow through the valve(s) stops, and the suction check valve(s) closes. This marks the return to point 1 and the end of the suction event, from which the cycle repeats. Comprehending this cycle helps to understand compressor efficiency, capacity or flow, power requirements, valve operation, etc., and to diagnose compressor problems.

The volumetric efficiency of a cylinder is the ratio, usually expressed as a percentage, of the actual volume of gas admitted into the cylinder during the suction event to the swept volume of the cylinder. The swept volume of the cylinder is the volume that is displaced by the piston as it moves through its strokes from one end (say, the head end at point 3) of the cylinder to the other end (the opposite end at point 1). From the preceding explanation of the expansion and suction events, the influence of clearance volume on the volumetric efficiency is clear. The gas in the clearance volume at point 3 at a higher pressure P2 must expand to the point 4 to a lower pressure P1 that is below the pressure in the suction plenum before suction gas can be admitted into the cylinder. If it were possible to design and manufacture a cylinder with zero clearance volume, volumetric efficiency would be 100% because there would be no residual gas at point 3 to expand in the compression chamber. Since some clearance volume is always present in the cylinder, volumetric efficiency is always less than 100%. Thus, it is apparent that additional clearance volume decreases the volumetric efficiency.

In addition to the clearance volume, the compression ratio and the properties of the fluid (i.e. polytropic gas exponent) also affect the volumetric efficiency. The compression ratio is the ratio of the absolute discharge pressure to the absolute suction pressure. The polytropic exponent is generally accepted to be the ratio of specific heats for a constant volume and a constant pressure (Cₚ/Cᵥ) for the fluid. For a given gas of a given composition, the ratio of specific heats is generally considered to be constant over the range of pressures and temperatures from suction to discharge. For the purpose of the following discussion, the influence of the ratio of specific heats on the volumetric efficiency will not be considered, because it is assumed that natural gas is the fluid medium and this property is essentially constant throughout the compression cycle.

A high compression ratio (discharge pressure to suction pressure) will decrease the volumetric efficiency, because the gas must expand more during the expansion event before the suction check valve(s) can open. Conversely, a lower pressure ratio will increase the volumetric efficiency because the fluid (gas) must expand less during the expansion event before the suction check valve(s) can open. A pressure ratio approaching unity will result in a volumetric efficiency approaching 100%; however, it should be noted that the work done on the gas would also approach zero and the gas would not be compressed when the pressure ratio is equal to unity.

For a given compression ratio and swept volume, the power requirements are proportional to the amount of gas admitted to the cylinder. Clearance volume can be added or removed from the cylinder with various devices for the purpose of controlling power, mass flow or both. It is clear that the amount of clearance volume has a profound effect on the power and mass flow. For a given clearance volume, the compression ratio can be increased to a critical value where the gas continues to expand until the piston reaches the opposite end of the stroke where the internal volume is at the maximum, at which point no gas has been admitted to the compression chamber, which results in a volumetric efficiency equal to zero and renders the cylinder ineffective. Conversely, for a given compression ratio, a critical value of clearance volume can be added to the cylinder that will reduce the volumetric efficiency to zero and render it ineffective. It can be seen that excessive clearance volume in the cylinder limits the functionality of the cylinder and excessive clearance volume may preclude the use of a cylinder in a particular application because it cannot meet the mass flow requirements.

Another detriment of excessive clearance volume is that, for an equivalent mass flow and compression ratio, cylinders with higher clearance volumes require larger bore diameters (internal diameters) than cylinders with lower clearance volumes. The use of the larger bore diameter cylinder with the higher clearance volume will increase the force or rod load on the compressor frame because the differential pressure in the cylinder is bearing against a larger piston area. In many cases, this larger cylinder will exceed the compressor frame rod load limitations, thereby precluding the use of the cylinder for the application, or requiring the use of a larger, more expensive frame to handle the higher forces and rod loads.

Excessive clearance volume can also have detrimental effects on the operating characteristics of the cylinder when it is operating over a range of conditions, and can lead to increased operating temperatures, erratic valve behavior, difficulty predicting the mass flow and power requirements, and less than optimal utilization of equipment, particularly when operating conditions are changing.

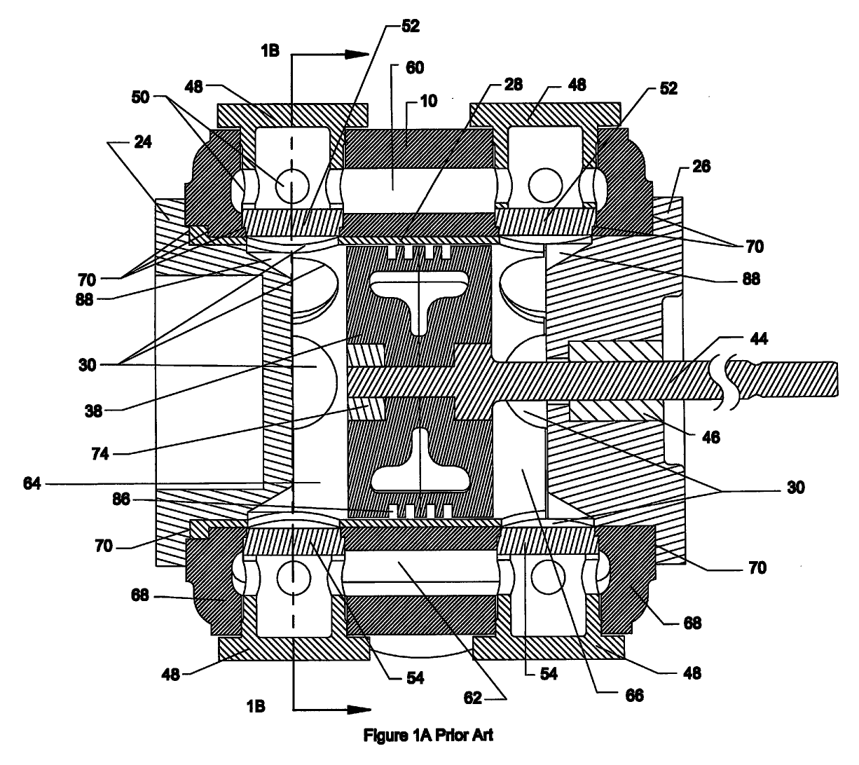

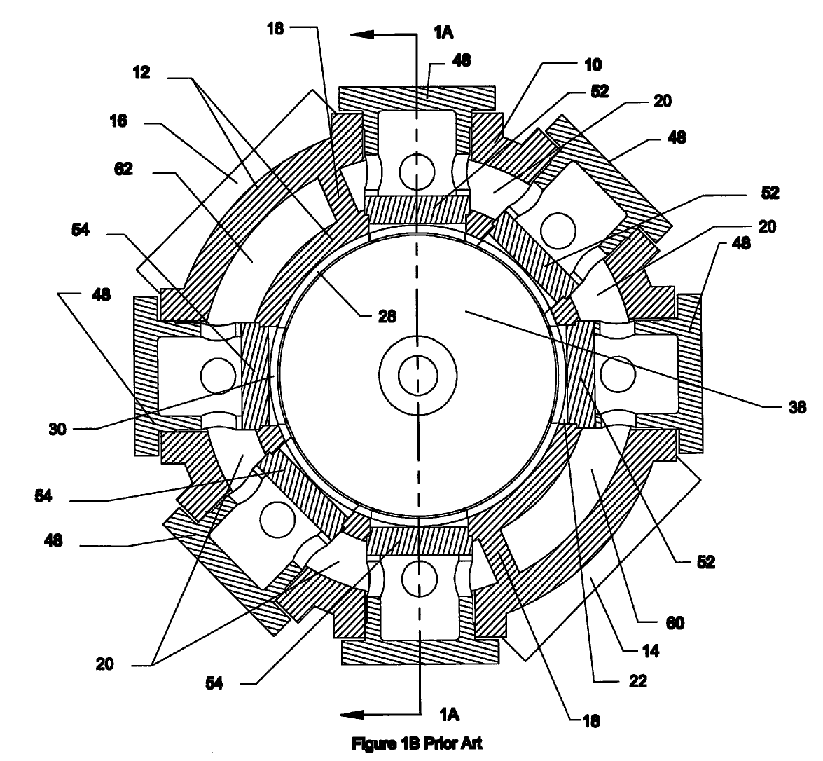

As illustrated in FIGS. 1A and 1B, the fundamental components comprising a typical prior art double-acting reciprocating compressor cylinder include a cylinder body [10], one or two cylinder heads [24,26] to close the ends of the cylinder body, a reciprocating piston assembly [38], piston sealing rings [86], a piston rod [44], piston rod seal packing [46], suction valve(s) [52], discharge valve(s) [54], and optionally, a liner [28]. In the case where only one head is used, a head end cylinder head [24] is provided and the opposing end of the cylinder body [10] is closed with a cylinder end wall that is integral to the cylinder body. The cylinder end wall provides the same function as the crank end head [26], however, the cylinder end wall is not a separable component and cannot be removed from the cylinder body [10]

Some cylinders are fitted with a cylinder liner [28] in the cylinder bore whereas some are not. The replaceable cylinder liner [28] provides a means of restoring the cylinder's running bore if wear or damage exceeds acceptable limits. It is also a means of changing the cylinder bore to a different diameter size if required for the application. This is generally more common on low and medium pressure ratio applications than on high pressure ratio applications, due to the detrimental effects that reducing the bore diameter with a liner have on the cylinder's fixed volumetric clearance. The liner's ports [30] have fixed geometry that typically matches the geometry of the cylinder body's valve pocket chamber ports [22] FIG. 1B. Parts of the flow passages between the cylinder bore and the valves [52,54] are formed by head ports [88] that are a permanent part of the cylinder head(s) [24,26] or cylinder end wall in the case where the crank end head [26] is an integral feature of the cylinder body [10]. The cylinder liner [28], which has a cylinder liner port [30] corresponding to each suction valve [52] and discharge valve [54], may be permanently fixed in place or, in some cases, it may be removable and replaceable.

For cases where an original cylinder liner [28] is replaced with a new, thicker liner having a smaller inside or bore diameter, the number, location and geometry of the cylinder liner ports [30] in the thicker, smaller bore diameter liner remain the same as in the original thinner, larger bore diameter cylinder liner [28]. The port geometries in the cylinder head(s) [88] or the end wall are not designed to be modifiable and therefore they stay the same when a smaller bore diameter liner is installed. The liner bore diameter change results in additional internal volume or fixed volumetric clearance being added to the cylinder. Reducing the bore diameter of the liner increases the clearance volume contributed by the liner ports, because the radial thickness of the liner increases while the port area remains constant. At the same time the smaller bore diameter results in less swept volume, making the percentage of volumetric clearance a much higher number that makes the cylinder less effective.

For cases where an original liner [28] is replaced with a new, thicker liner having a smaller inside diameter or bore, the number, location, size and geometry of the suction valves [52] and discharge valves [54] that are used with the thicker, smaller bore diameter liner remain the same as they were for the original thinner, larger bore diameter liner.

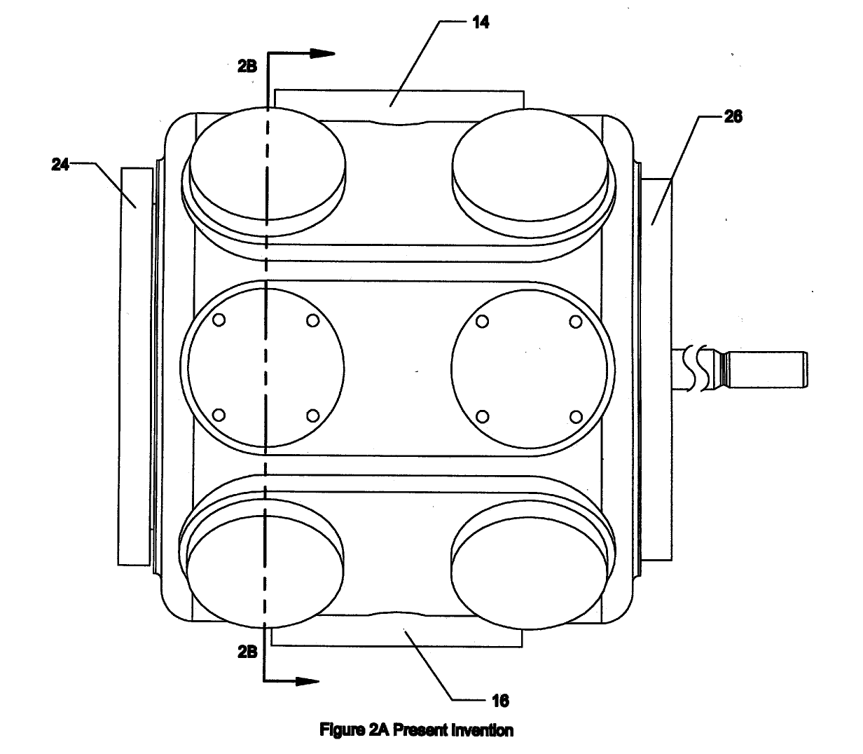

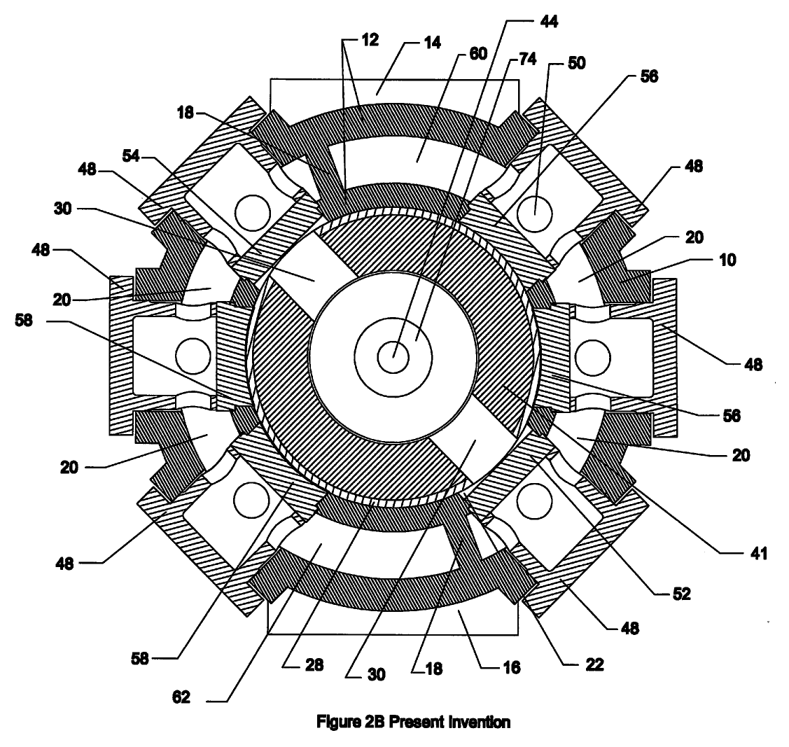

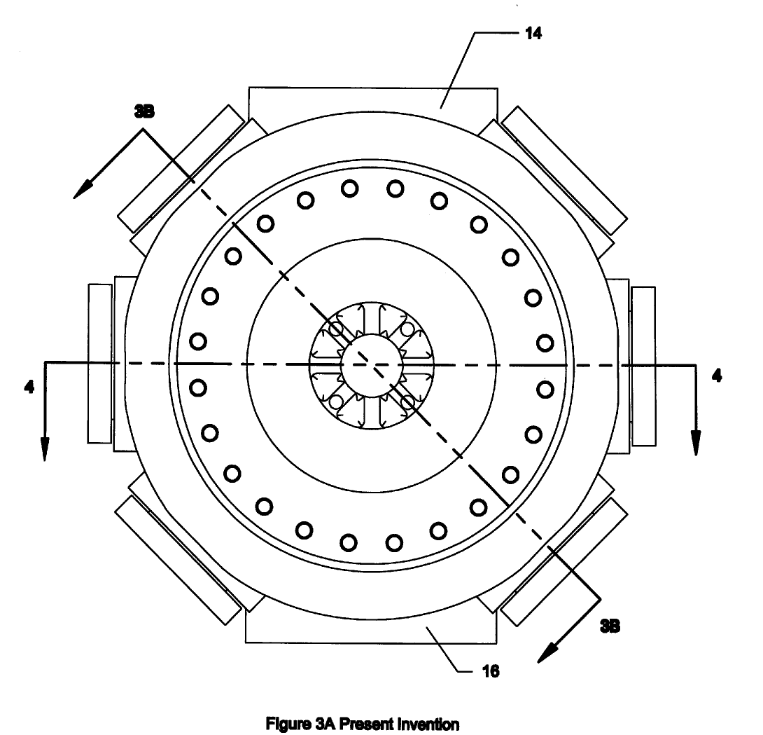

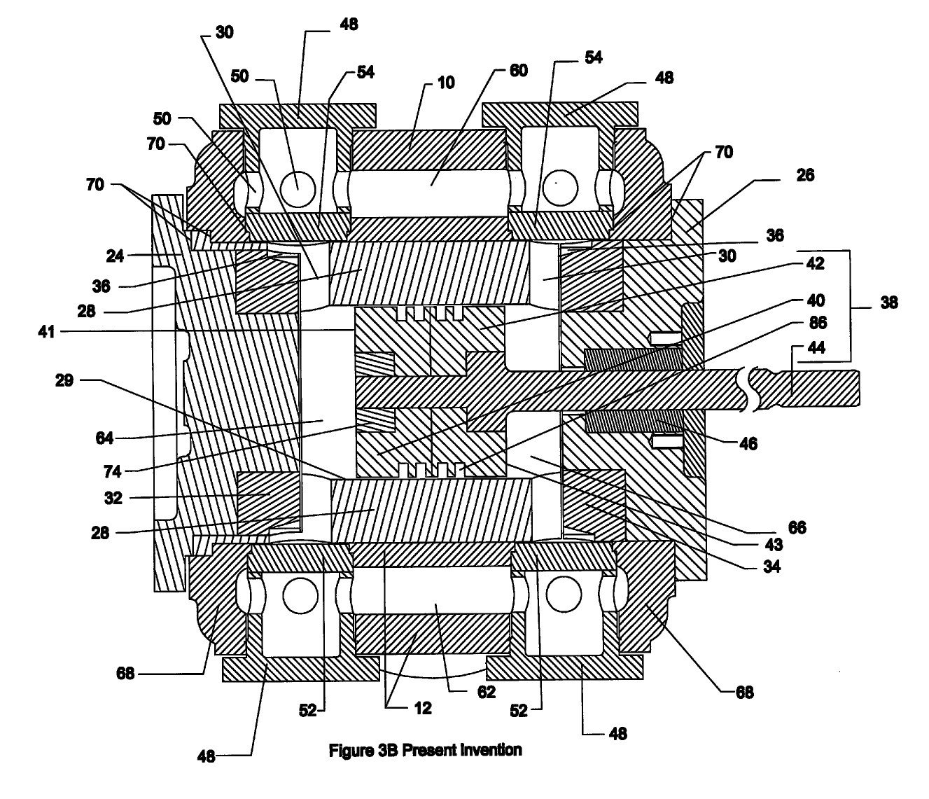

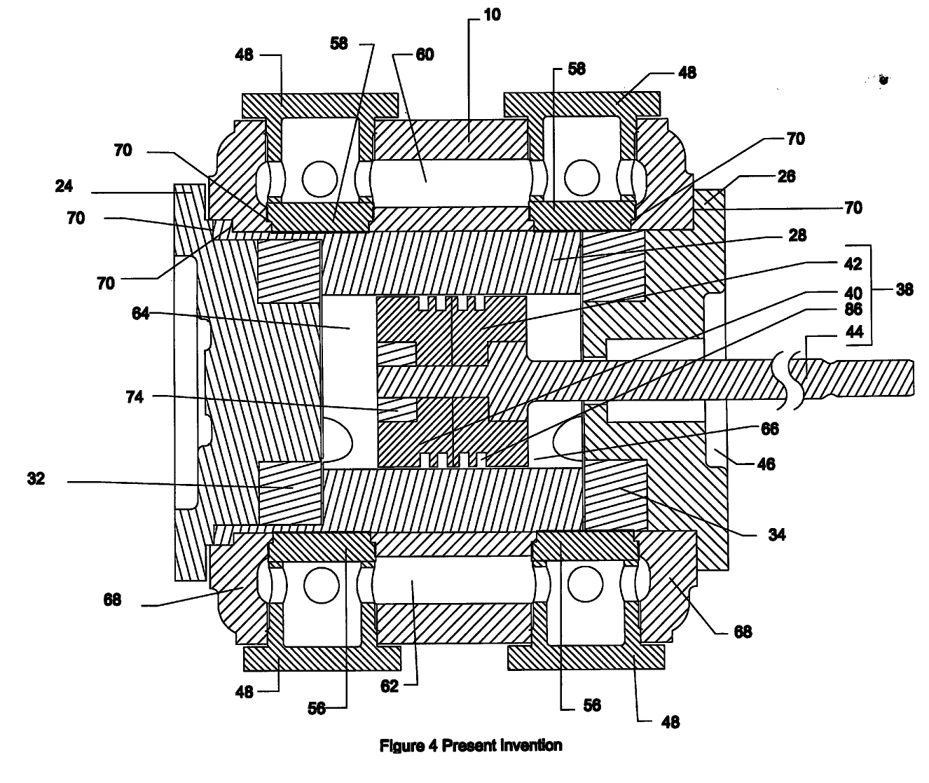

FIGS. 2A, 2B, 3A, 3B, 4A, 4B, and 10 show a first embodiment of the Cylinder Assembly of the present invention utilizing valve plugs [56, 58], as configured with one (1) suction valve [52] and one (1) discharge valve [54] on the respective head end and crank end of the cylinder. The cylinder can accept up to three (3) suction valves [52] and three (3) discharge valves [54] on the head end as well as on the crank end of the cylinder.

The cylinder assembly illustrated in FIGS. 2, 3 and 4 includes a cylinder body [10] having two (2) concentric cylinders [12] terminated at both ends with an integral flat wall section [68]. A suction flange [14] and a discharge flange [16] for process gas piping connections are located at the midsection and top and bottom, respectively, of the cylinder. Two (2) dividing walls [18] imposed between the inner and outer cylinders form the suction plenum [60] and discharge plenum [62]. These plenums isolate the high side (discharge) line pressure from the low side (suction) line pressure. The suction flange [14] and discharge flange [16] communicate with the suction plenum [60] and discharge plenum [62], respectively. Radially disposed valve pocket chambers [20] located at both ends of the cylinder are evident in FIG. 2B. The cylinder body shown has six (6) valve pocket chambers [20] at each cylinder end for a total of twelve (12) valve pocket chambers [20], however, it should be noted that a different quantity, for example as few as two (2) per end to as many as eight (8) or more per end, of valve pocket chambers [20] can be used. Six (6) of the valve pocket chambers [20] are for the suction valves [52] and six (6) of the valve pocket chambers are for the discharge valves [54]. The suction valve pocket chambers [20] communicate with the suction plenum [60], and the discharge valve pocket chambers communicate with the discharge plenum [62].

A separable cylinder liner [28] is located inside the innermost cylinder of the cylinder body [10]. As shown, the liner is dry and is not liquid cooled, however, this invention does not preclude the use of a liquid cooled liner. The cylinder liner [28] contains radially distributed liner ports [30] on both ends to direct gas flow to the suction valve(s) [52] and the discharge valve(s) [54]. The port location and geometry and the position of the valve relative to the face of the head can be designed so that masking of the liner ports [30] by the piston is minimized. This can be accomplished by positioning the liner port(s) [30] as close as practicable to the face of the cylinder head(s) [24,26] to minimize the duration that the piston covers the port and making the port as wide as practicable in the transverse direction. This reduces the pressure loss through the liner port [30]. An alternative to the preceding is to provide a rectangular port [72] designed so that it aligns with the position of the external profile of the piston face at the end of the compression event when the discharge valve opens. The rectangular port [72] alignment may be optimized or adjusted as required to suit a range of expected operating conditions if the operating conditions are not constant. This tuning of the rectangular port [72] feature reduces the clearance volume contribution of the port without sacrificing the effective port flow area due to piston masking. The end of the cylinder liner [28] is flanged and resides within a counterbore located in the cylinder body [10]. The cylinder liner [28] is retained by the shoulder on the head end cylinder head [24] and the counterbore in the cylinder body [10]. O-rings and/or flat gaskets are utilized with the liner as required to seal lubricating oil and process gas.

A reciprocating Piston Assembly [38] reciprocates inside the cylinder liner [28], and includes the head end piston half [40], the crank end piston half [42], the piston rod [44], and the piston rings [86]. The head end piston half [40] and the crank end piston half [42] are typically attached to the piston rod [44] with multiple screw type fasteners or a single threaded piston nut [74]. The piston rings [86] seal the gas between the piston assembly and the cylinder liner [28]. In some cases, the piston is supported by rider rings or bands that carry the weight of the piston. In other cases, dual function, combination rider/piston rings [86] may be used to support the piston and to seal the gas between the cylinder liner [28] and the piston assembly.

A head end cylinder head [24] and a crank end cylinder head [26] contain the pressure in the compressor cylinder body [10], and are typically attached to the cylinder body [10] with screw fasteners. The head end cylinder head [24] accepts an annular shaped separable head end port ring [32] and the crank end cylinder head [26] accepts a separable annular shaped crank end port ring [34], both of which are typically attached to the heads with screw fasteners. The head end port ring [32] and the crank end port ring [34] contain radially distributed ports [36] to direct gas flow to the suction valve(s) [52] and the discharge valve(s) [54]. The port rings may be configured as a one-piece ring or a segmented annular ring design consisting of a set of multiple annular sectors. The shape of the port rings is not necessarily limited to a one piece annular ring or a set of multiple annular sectors. In some cases, it may be desirable to incorporate and integrate either one or both port rings [32,34] into the cylinder liner [28] so that the ports 36 become features of the liner [28]. The crank end cylinder head [26] accepts piston rod packing [46], which seals the clearance space between the crank end cylinder head [26] and the piston rod [44]. The piston rod packing [46] is typically attached to the crank end cylinder head [26] with screw fasteners.

Suction valve(s) [52] and discharge valve(s) [54], acting as check valves (assemblies having moveable internal sealing elements that permit flow in only one direction), control the gas flow in and out of the cylinder, respectively as the piston assembly reciprocates. The suction valve(s) [52] and discharge valve(s) [54] reside within radially disposed counterbores located in both ends of the cylinder body [10]. Gaskets [70] positioned between the cylinder body [10], the suction valve(s) [52] and discharge valve(s) [54] seal the process gas between the plenums [60,62] and the compression chambers [64,66].

Two (2) separate compression chambers, a head end compression chamber [64] and a crank end compression chamber [66], are formed between the respective head(s) [24, 26], the respective face(s) [41, 43] of a piston assembly [38], and the cylinder liner [28] on respective ends of the cylinder body [10]. In the case of the double-acting design, the head end compression chamber [64] is formed by the head end cylinder head [24] and the head end port ring [32] assembly, the face [41] of the head end piston half [40], and the bore [29] of the cylinder liner [28]. The crank end compression chamber [66] is formed by the crank end cylinder head [26] and the crank end port ring [34] assembly, the face [43] of the crank end piston half [42], and the bore [29] of the cylinder liner [28]. The suction and discharge check valves [52,54] that are interposed between the compression chambers [64,66] and the suction and discharge plenums [60,62] control the gas flow direction from the suction plenum [60] to the compression chamber [64,66] and from the compression chamber [64,66] to the discharge plenum [62] as the piston assembly reciprocates. The suction and discharge plenums [60,62] are connected to and communicate with suction and discharge piping systems, respectively, that are connected to the suction [14] and discharge [16] flanges located on the cylinder body [10].

Valve retainers [48] retain the suction valve(s) [52] and discharge valve(s) [54] in the cylinder body [10] and contain the pressure in the cylinder assembly. The valve retainers [48] are provided with radially disposed valve retainer ports [50] to allow gas to flow to the suction valve(s) [52] and from the discharge valve(s) [54]. The valve retainers [48] also retain the suction valve plug(s) [56] and discharge valve plug(s) [58], described below in the cylinder to contain the pressure in the cylinder assembly. The valve retainers may be one piece as shown or they may be an assembly of one or more cylindrical spacers and a top cap or cover. The valve retainers [48] are typically attached to the cylinder body [10] with screw fasteners. O-rings and/or gaskets are utilized with the valve retainers [48] as required to seal process gas.

The suction valve plug(s) [56] and discharge valve plug(s) [58] are used to block flow through the valve pocket chamber ports [22] for the valve pocket chambers [20] that are not fitted with suction valves [52] and discharge valves [54]. The innermost surface of the suction valve plug(s) [56] and discharge valve plug(s) [58] can either be flat a saddle shaped inner contour. The unique saddle shape, which has a contour that matches the outer diameter of the cylinder liner [28], reduces the clearance volume in the cylinder to a minimal value, but at the expense of higher manufacturing costs. It is possible to eliminate the suction valve plug(s) [56] and discharge valve plug(s) [58] for the head end or crank end valve pocket chambers if the cylinder liner [28] is designed without liner port [30], and to fully cover the valve pocket chamber ports [22] where valves are not required. It should also be noted that it is possible to eliminate the suction valve plug(s) [56] and discharge valve plug(s) [58] for the crank end valve pocket chamber if the crank end port ring [34] is integrated with the cylinder liner [28].

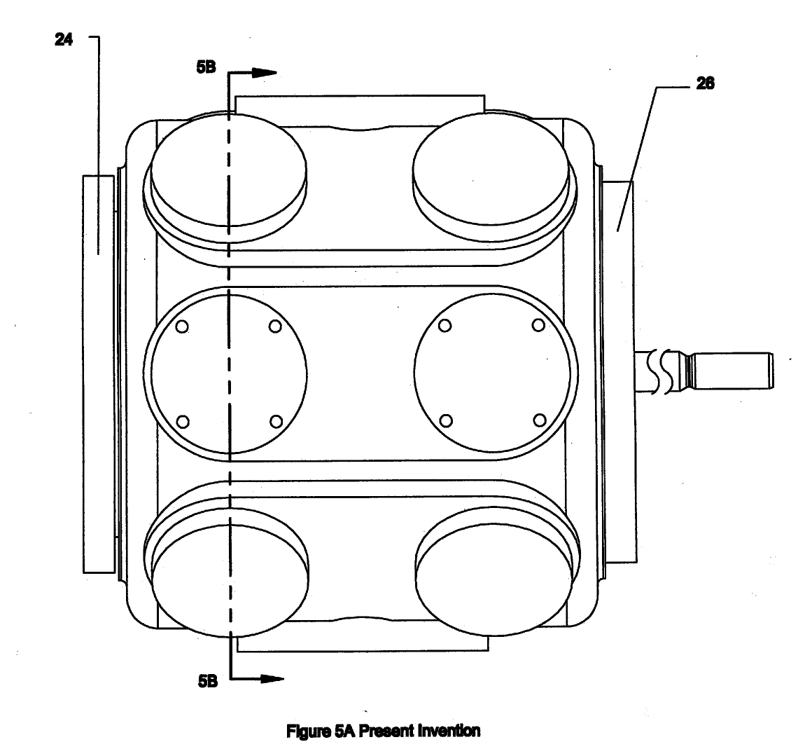

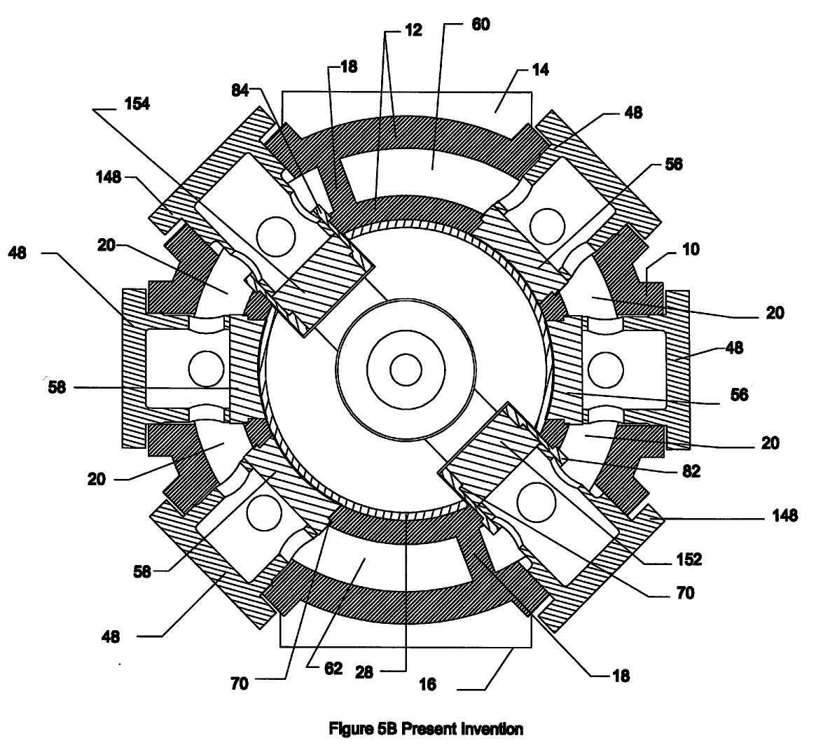

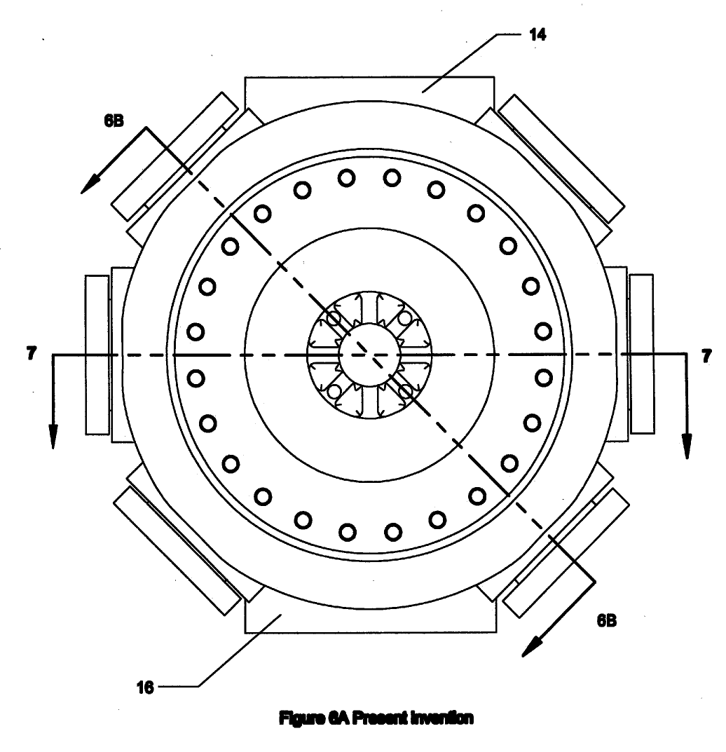

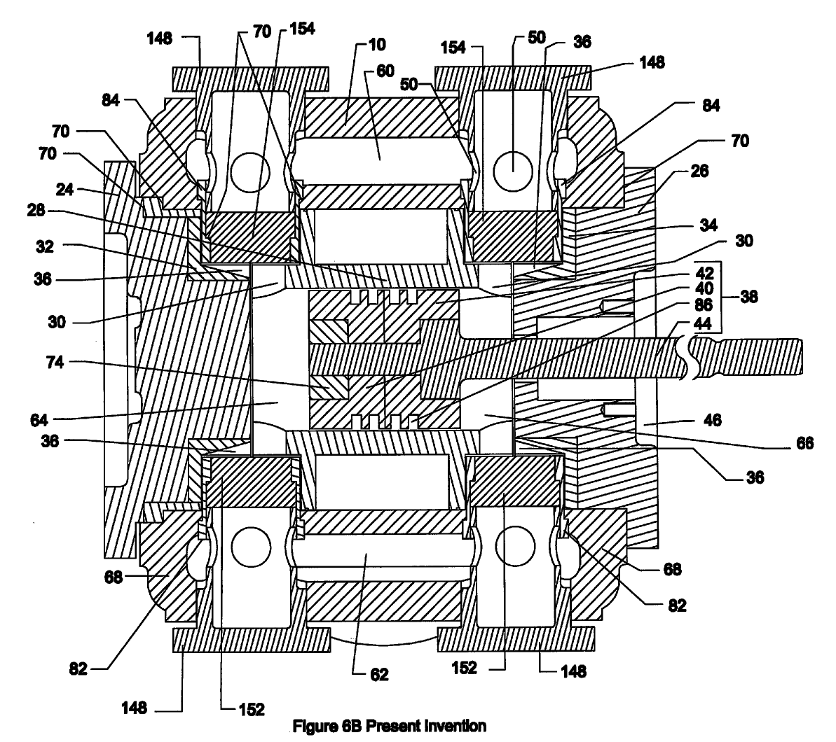

FIGS. 5A, 5B, 6A, 6B ,7 and 10 depict a second embodiment of the invention utilizing valve extension insert/adapter(s) [82, 84], as configured with one (1) suction valve [52] and one (1) discharge valve [54] on the head end and crank end of the cylinder.

Extended suction valve(s) [152] and discharge valves(s) [154], extend into counterbores machined into the head end port ring [32] and the crank end port ring [34], respectively, and are retained with suction valve extension insert/adapter(s) [82] and discharge valve extension insert/adapter(s) [84]. The valve extension inserts [82,84] may be eliminated and replaced with longer valve retainers [148] if either one or both port rings [32,34] are integrated into the cylinder liner [28] (so that the port rings [32,34] are eliminated) and the port ring features become features of the cylinder liner [28]. This modification provides a suitable sealing surface on the cylinder liner [28] for the valves [152,154] to seat against. A gasket [70] is interposed between the valves [152,154] and the cylinder liner [28].

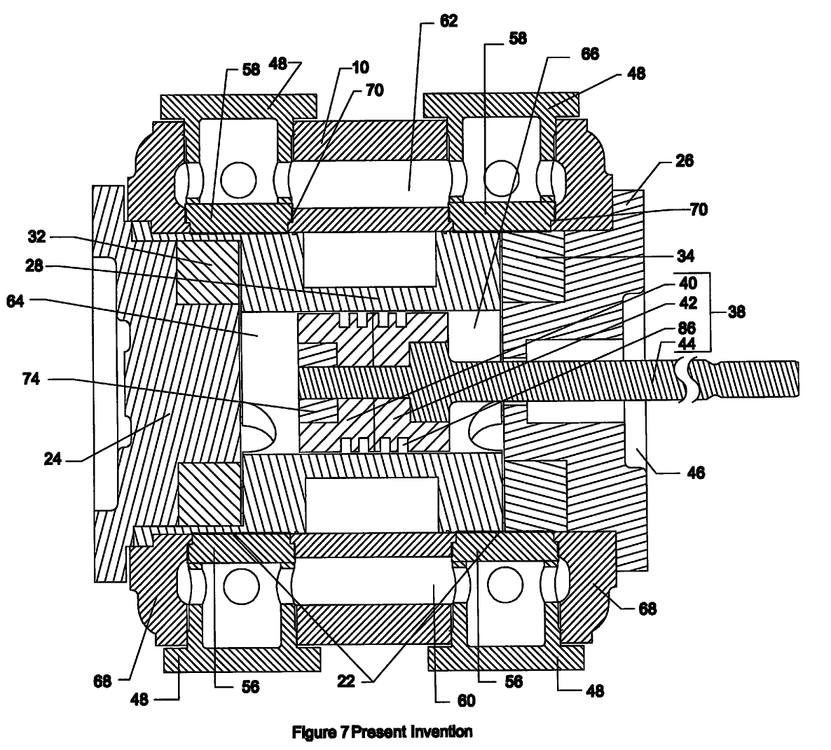

A compressor fitted with the improved variable bore convertible cylinder invention can be reconfigured with larger or smaller cylinder bores in the field as the compression requirements change. This can be accomplished by first removing together the head end cylinder head [24] with the head end port ring [32]. The piston assembly [38] is then removed from the cylinder assembly. If the cylinder assembly is configured as in the embodiment depicted in FIGS. 5-7, the suction valve(s) [152], discharge valves(s) [154], suction valve extension insert/adapter(s) [82] and discharge valve extension insert/adapter(s) [84] would be removed from the cylinder assembly. The cylinder liner [28] is then removed from the cylinder assembly. The crank end port ring [34] is then removed from the in situ crank end cylinder head [26] and replaced with a new crank end port ring [34] possessing the proper port configuration, if required. The existing head end port ring [32] is removed from the head end cylinder head [24] and replaced with a new head end port ring [32] possessing the proper port configuration, if required. A new cylinder liner [28] having a new bore diameter is installed in the cylinder body [10]. A new piston assembly [38] having a diameter that matches that of the new cylinder liner [28] is installed in the cylinder assembly. Also, suction valve(s) [152], discharge valves(s) [154], suction valve extension inserts/adapters [82], discharge valve extension insert/adapter(s) [84], suction valve plug(s) [56], discharge valve plug(s) [58] and valve retainers [148] would be installed in the cylinder assembly as required for the application. If the cylinder assembly is configured as in the embodiment depicted in FIGS. 2-4, then suction valve(s) [52], discharge valve(s) [54], suction valve plug(s) [56], discharge valve plug(s) [58], and valve retainers [48] would be installed as required for the application.

The preceding modifications can be made without removing the cylinder assembly from the compressor frame or removing or disturbing any of the piping or pulsation suppression devices. This characteristic greatly reduces the time and cost of reconfiguring a compressor package or system for new operating conditions or a new application.

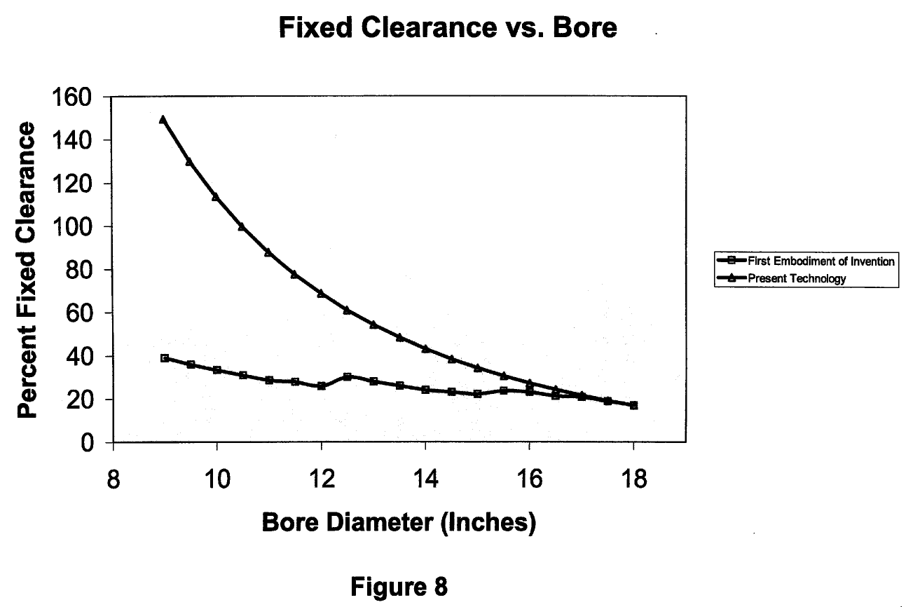

The improved variable bore convertible cylinder described herein reduces the fixed clearance volume when the liner bore diameter is reduced, providing a much greater range of usable cylinder bore diameters for a given compressor cylinder body. FIG. 8 compares fixed clearance versus bore diameter of prior art cylinders compared to the First Embodiment of the present invention. The present variable bore convertible cylinder eliminates most of the typically eight or more cylinder classes that are usually required to cover the range of wellhead and gas gathering applications, such that only one or two of the present variable bore convertible cylinder classes can accommodate a large percentage of wellhead and gas gathering applications. The variable bore convertible cylinder of the present invention also enables much easier, faster, and lower cost field conversions to accommodate changing operating conditions in the field or new applications.

The present invention is predicated upon the rationalization that fewer and/or smaller valves can be used to reduce clearance volume as the cylinder bore is reduced, and that smaller and/or fewer optimized liner and head ports can be used to reduce clearance volume. Current devices do not subscribe to this rationale. As a result, reciprocating compressor manufacturers have a significant number of cylinder classes to cover the full range of applications and operating conditions.

As the cylinder liner bore diameter is reduced, the piston displacement (swept volume) decreases, which in turn decreases the mass flow through the cylinder. This reduction in mass flow lowers the gas velocities through the valves, liner ports, and head ports. The lower velocities result in lower pressure losses through the valves, liner ports and head ports. As the bore is reduced, the flow areas through the valves, liner ports and head ports can be reduced while maintaining the same overall pressure losses as the cylinder with a larger bore. Smaller ports result in lower clearance volumes. As the bore diameter is reduced, the liner ports and head ports can be reduced in size to reduce the fixed clearance volume while maintaining acceptable gas velocities and pressure losses through the valves and ports.

As the bore diameter is further reduced, a point is reached where some of the valves can be removed from the cylinder because the gas velocities through the remaining valve(s) are reduced to acceptable levels. Each valve that is not required is removed from the cylinder and is replaced with a flat disc or a saddle shaped plug. The unique saddle shape reduces the clearance volume in the cylinder to a minimal value. Each liner port corresponding to the adjacent valve removed from the cylinder can also be eliminated which further reduces the clearance volume. Each head port in the cylinder heads that correspond to the adjacent valve removed from the cylinder can also be eliminated which further reduces the clearance volume.

In a conventional “valve-in-body” cylinder manufactured according to prior art, the port(s) in the cylinder liner and cylinder body that feed the valve(s) typically have a projected profile that resembles and approximates an ellipse or oval. The shape of the cutout is colloquially referred to as the “cat eye” in the reciprocating compressor industry. The elliptical port major axis aligns with the cylinder body or cylinder liner bore axis. The minor axis of the elliptical port is perpendicular to the cylinder body or cylinder liner bore axis. The elliptical shape is the net result of the partial intersection of a conical machine tool cutter (inserted through the valve pocket chamber) with the bore of the cylinder body or the cylinder liner. The elliptical port geometry is used because it contributes less clearance volume to the cylinder body assembly as compared to a circular port with a diameter equal to the elliptical port across the major axis. It should be noted that the elliptical port has a projected area less than that of a circular port with a diameter equal to the elliptical port across the major axis.

In the case of a conventional “valve-in-body” cylinder manufactured according to prior art, there are operating points (that are a function of the pressure ratio of compression and the clearance volume), where the piston covers or masks a portion of the cylinder body valve pocket chamber port(s) or cylinder liner port(s) that feeds the discharge valve(s) when the valve(s) are open. These operating points generally occur during relatively high (approximately 2.5 or higher) compression ratios. For these operating conditions, the portion of the port that is covered by the piston is rendered ineffective. The covered portion of the port does not provide any contribution to the effective port flow area. The covered portion of the port does not have any positive attributes, but it does have a negative attribute in that it adds to the clearance volume of the cylinder.

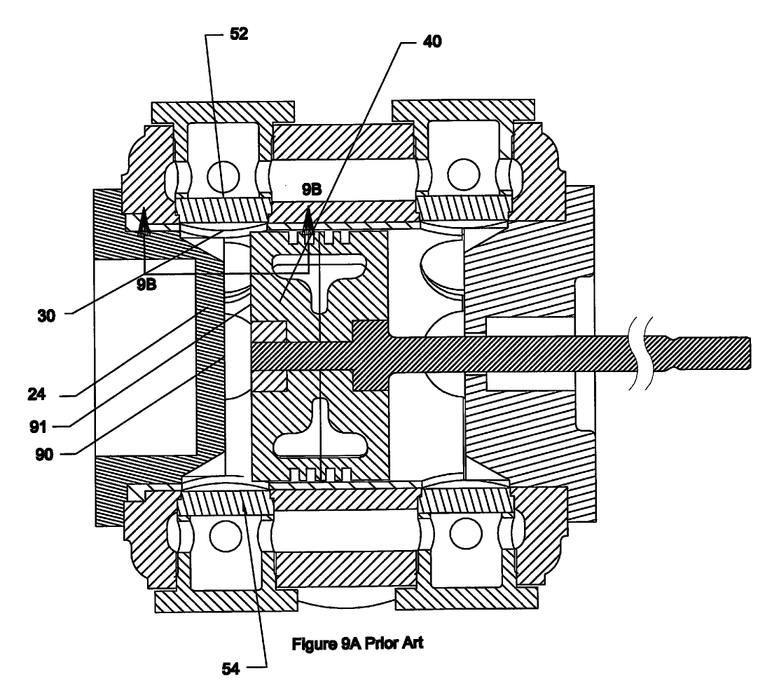

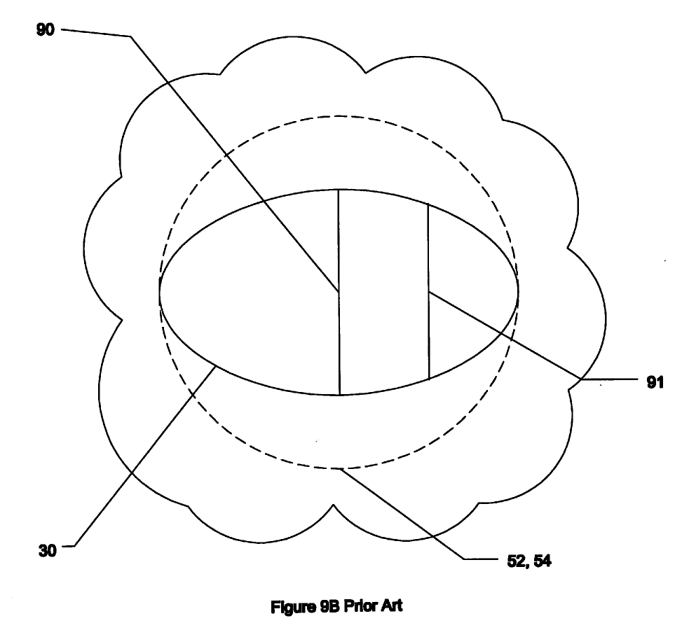

The present invention does not utilize the traditional oval/elliptical porting in the cylinder body but instead uses cylindrical ports that completely intersect the main bore in the cylinder body. The projected area of the cylindrical port forms a circle. This results in a port that is wider than the traditional elliptical port in the transverse direction. The cylindrical port has more flow area and better flow characteristics at the expense of slightly higher clearance volume; however, this additional clearance volume contribution is negated by including special porting in the cylinder liner that is described in the following paragraph. The circular port also simplifies the manufacturing of the cylinder body. The differences between the valve ports of the present invention as compared to prior art elliptical valve ports is illustrated in FIGS. 9, 10, 11 and 12.

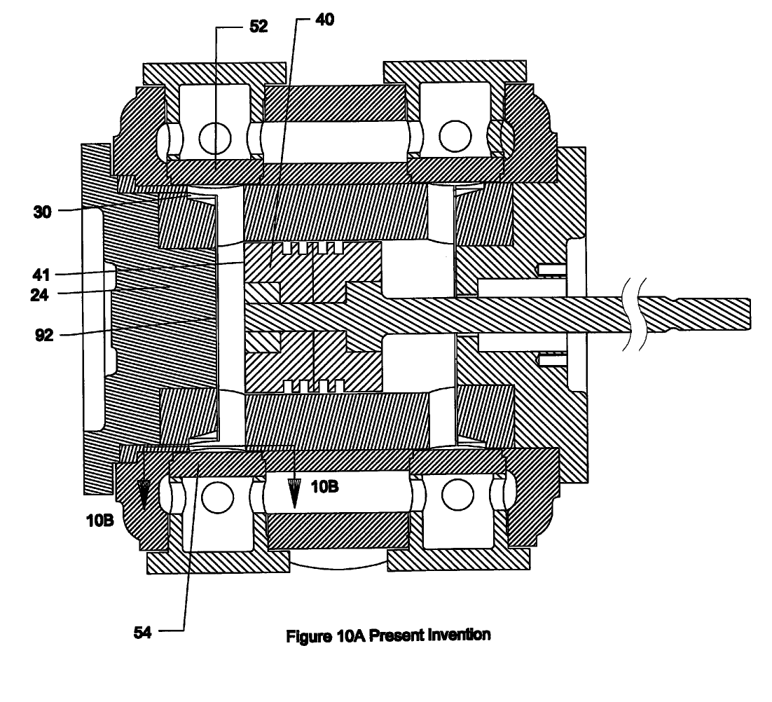

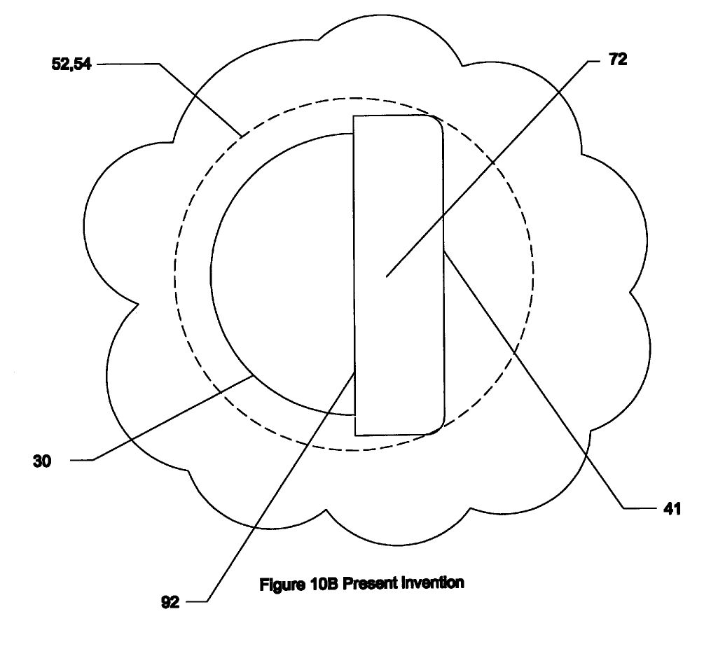

The present invention utilizes discharge porting that consists of a semicircular port(s) that is merged with and adjacent to a rectangular port(s) machined in the cylinder liner. The leading edge of the rectangular discharge port is designed so that it aligns with the edge of the piston face when the discharge valve opens. This tuning of the rectangular port feature reduces the clearance volume contribution of the port (as compared to the long, elliptical port) without sacrificing the effective port flow area due to masking as previously described. The rectangular porting can be tailored to match a specific operating point (compression ratio and clearance volume) or to operate within a range of operating conditions (between compression ratios) to minimize clearance volume. Because the circular port in the cylinder body is wider than the traditional elliptical port, the rectangular port in the liner can be made as wide as the circular port in the cylinder body which results in an effective flow area greater than the traditional elliptical port. As a result of this design improvement, the rectangular port minimizes clearance volume while providing greater effective flow area which reduces flow losses. FIGS. 9 and 10 illustrate the comparative difference of flow areas between the present invention and present art. The use of the special porting is not restricted to the discharge valve [54] and can be used with the suction valve [52]. It should also be noted that the piston is unmasking the cylinder liner suction port [30] after the suction valve [52] opens whereas the piston is masking the cylinder liner discharge port [30] after the discharge valve [54] opens. In the case where the suction valve [52] opens while the piston is still covering the valve pocket chamber port(s) [22] or cylinder liner ports [30], the location of rectangular port [72] in the liner can be tuned to expose the full port area sooner than the elliptical port resulting in lower suction port losses.

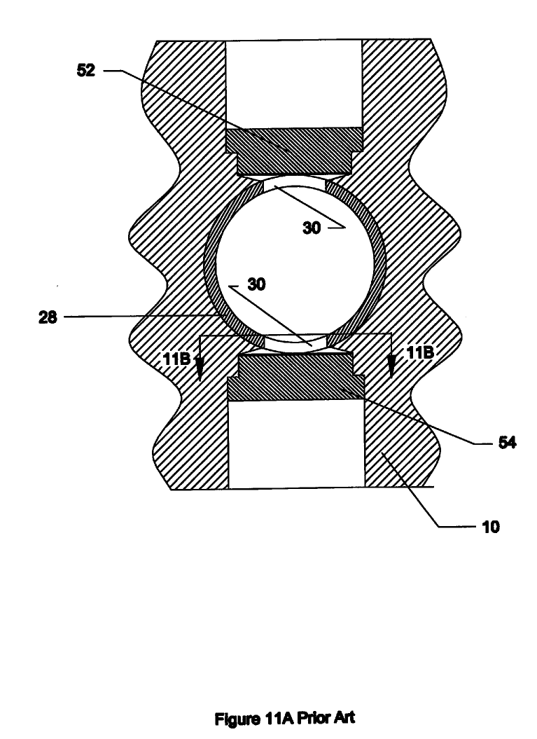

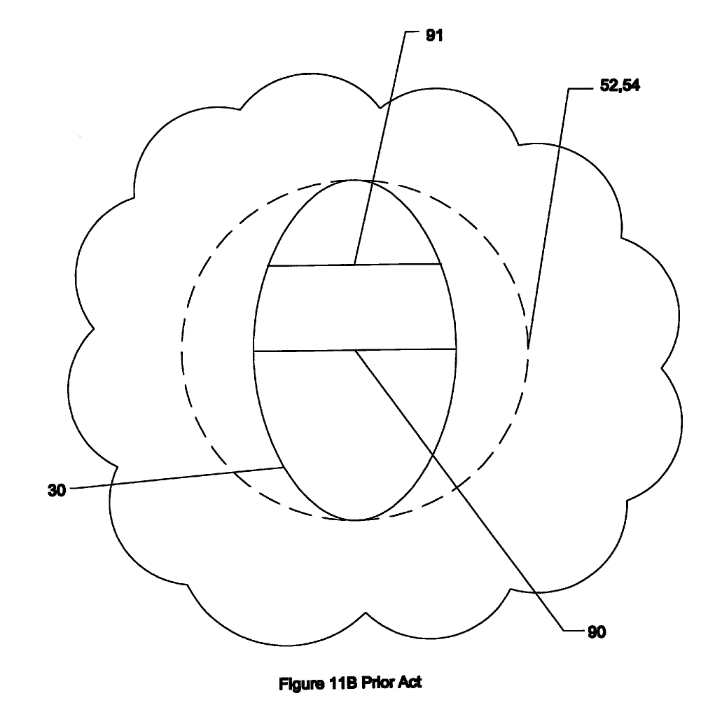

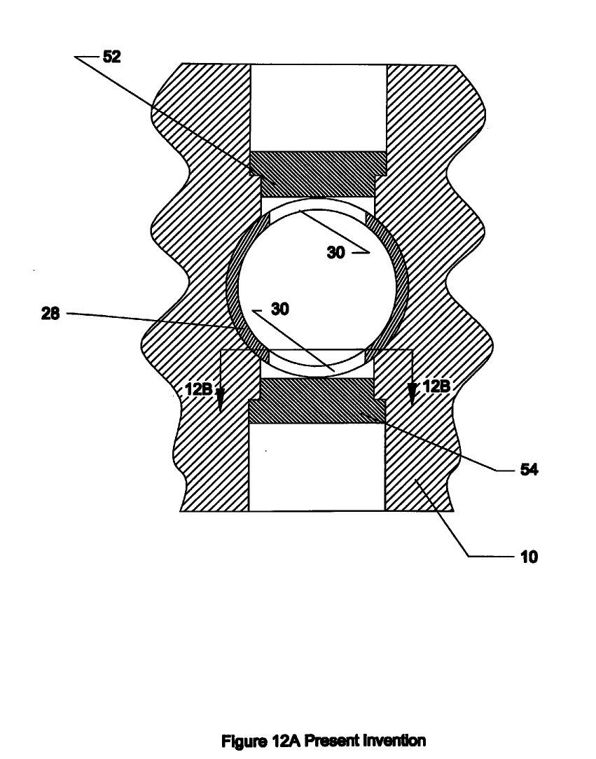

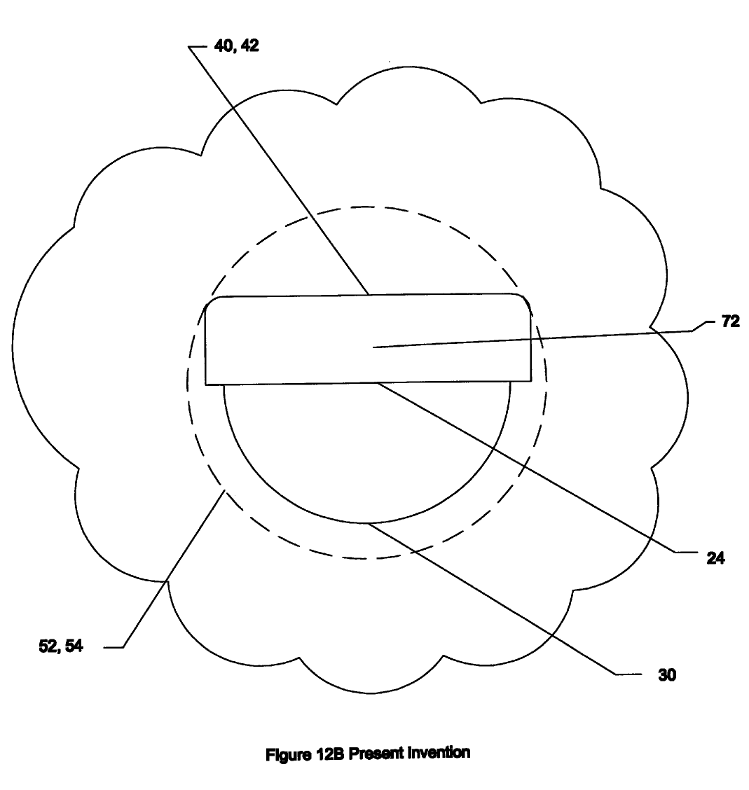

An additional benefit of the circular suction and discharge valve pocket chamber ports [22] that intersect the cylinder body bore is that it affords additional flow area to feed the portion of the valve(s) covered by the piston compared to the traditional elliptical port design (See FIGS. 11 and 12). In the case of the discharge event, the gas flows from the compression chamber [64, 66] through the cylinder liner port [30]. After the gas emerges from the cylinder liner port [30], the gas that feeds to the covered portion of the discharge valve [54] turns 90 degrees and flows over the outside of the cylinder liner [28] before it passes through discharge valve [54].

In the case of the suction event, gas flows from the portion of the suction valve [52] covered by the piston over the outside of the cylinder liner [28] to the cylinder liner port [30]. The gas turns 90 degrees and then passes through the cylinder liner port [30]. The gas then emerges from the cylinder liner port [30] into the compression chamber [64, 66].

This increase in flow area that feeds the covered portion of the valves over the traditional impeded elliptical port results in lower port losses. Additional scallops or reliefs can be added to the outside diameter of the cylinder liner [28] around the cylinder liner ports [30] to increase flow area and further facilitate flow to the portion of the valve covered by the piston. FIGS. 11 and 12 illustrate the comparative difference of flow areas between the present invention and present art.

Another improvement of the present invention over the prior art is based on the rationalization that the velocity of the piston is different for the head end and crank end of the cylinder. The piston velocity is lower on the crank end as compared to the head end. This variation is due to the finite length of the connecting rod. An infinitely long connecting rod would impart equal piston velocities for the head and crank end. The port areas for the head and crank end are adjusted and optimized accordingly to the piston velocities to yield acceptable flow losses and to minimize clearance volumes. Also, the variation in swept volume between the head and crank ends due to the piston rod displacement on the crank end are accounted for and used accordingly to optimize port sizing to yield acceptable flow losses and to minimize clearance volumes.

Additional flow area and geometrical optimization of the liner and head porting is accomplished via standard compressible orifice flow calculations based on flow restrictions in series, or numerical computational fluid dynamics (CFD, and/or experimental testing.

The improved, lined, high pressure reciprocating compressor cylinder lowers flow losses and reduces the clearance volume as the liner bore diameter is reduced by applying any combination of the following features:

Eliminating the valves that are not required for the application. As the bore diameter is reduced, a point is reached where some of the valves can be removed because the valve gas velocities are reduced. Each valve that is not required is removed from the cylinder and replaced with a flat disc or saddle shaped plug that reduces the clearance volume.

Eliminating the ports in the liner that correspond to the adjacent valves removed from the cylinder to reduce the clearance volume.

Reducing the liner port area to an optimized value that minimizes clearance volume while maintaining acceptable liner port velocities.

Eliminating head ports in the cylinder heads that correspond to the adjacent valves removed from the cylinder to reduce the clearance volume.

Reducing each head port area to an optimized value that minimizes clearance volume while maintaining acceptable head port velocities.

Aligning the leading edge of the rectangular liner port(s) with the face of the piston when the discharge check valve opens to eliminate the ineffective flow area that is covered by the piston to reduce the clearance volume.

Aligning the trailing edge of the rectangular liner port(s) with the face of the piston when the suction check valve opens to eliminate the ineffective flow area that is covered by the piston to reduce the clearance volume.

Increasing the flow area between the check valve and the outside diameter of the cylinder liner by using circular suction and discharge ports that intersect the cylinder body bore instead of the traditional elliptical porting.

Accounting for the difference in piston velocities between the head and crank ends of the cylinder to optimize the size of the valve ports for each end of the cylinder.

Accounting for the swept volume difference between the head and crank ends of the cylinder to optimize the size of the valve ports.

Use of the preceding modifications enable the cylinder liner bore diameter to be reduced to a lower practical limit before clearance volumes eventually become too large and/or flow velocities (and the corresponding power losses) become too high. When this limit is reached, additional modifications can be made which allows the bore diameter to be reduced even further without significant increases in clearance volume. Valve extension insert/adapter(s) can be added to adapt a smaller valve(s) to the cylinder or to move the proximity of the smaller valve(s) nearer to the liner bore to reduce the liner port clearance volume(s). Smaller valves can be used because the lower capacity or flow rate resulting from the reduced bore diameter does not require the larger valves that were needed for the larger bore diameters. These modifications result in a flexible bore cylinder with clearance volumes that are comparable to values associated with fixed bore cylinders manufactured according to the present art. As also described in the first embodiment, valves, liner ports, and head ports can be eliminated as the bore diameter decreases, and the liner ports and head port flow areas can be reduced as required to reduce clearance volume.

Establishing a cylinder bore range index is useful for gauging the versatility of the present invention. As previously explained, cylinders are lined to provide changes in swept volume. For a given stroke, the swept volume changes with the square of the bore diameter. An index formula that takes the largest bore diameter squared divided by the smallest bore diameter squared yields a value that is the factor by which the largest swept volume for a cylinder class exceeds the smallest swept volume for a given cylinder class. Sleeved cylinders manufactured according to present art typically have a cylinder bore range index of about 1.15 to 1.25 for each class of cylinder. Reducing the bore diameter to increase the cylinder bore range index to a value higher than this range based on present art results in excessive fixed clearance volume and unacceptable performance.

The invention described herein and illustrated in FIGS. 2-4 can provide a cylinder bore range index that exceeds 2.50 for each class of cylinder by eliminating unnecessary valves, liner ports, head ports and the optimization of the remaining ports. FIG. 8 illustrates clearance volume versus bore diameter for a prior art cylinder and the present invention as described herein and depicted in FIGS. 2-4.

Incorporation of the valve extension insert/adapter(s) [82,84] described herein and illustrated in the embodiment depicted in FIGS. 5-7 in conjunction with the methods described herein and depicted in FIGS. 2-4 can extend the cylinder bore range index up to a maximum value of 9.0. This is a 7.2 times improvement (9.0/1.25=7.2) over the present art while maintaining the flow losses and clearance volumes that are comparable with the larger bores.

The present invention significantly reduces the number of different cylinder bodies required to cover the majority of applications for a particular compressor frame. This invention also allows for simplified field retrofits for commissioned compressors that are subjected to changing operating conditions. Compressor packages can also be easily reconfigured in the field to operate at different sites which reduces the number of idle and underutilized compressor packages. These characteristics reduce the cost of maintaining compressors in optimal configurations for maximizing their utilization, production capacity and efficiency. The number of cylinder assemblies and associated piping and pulsation control vessels required to fulfill differing applications is significantly lower resulting in lower inventories and lower capital costs.

The utility of the Variable Bore Cylinder Invention as described herein arises when field operating conditions change or a compressor needs to be re-configured for a different application.

Natural gas compressors are usually configured with 1, 2, or 3 stages of compression. In some applications with very low suction pressures, 4 stages are required. Each stage successively reduces the volume of gas being compressed with cylinders of progressively smaller displacement. One or more cylinders may be used for each stage of compression.

Generally speaking, the size of the cylinders for each stage decreases as the gas is progressively compressed through the succeeding stages; however, it is possible to have cylinders that are smaller than the successive stages if multiple cylinders are used for a particular stage. The reduction of the gas volume results in a corresponding increase in pressure and temperature of the gas. The gas is typically cooled between the stages with external heat exchangers.

The number of stages required for an application usually depends on the overall ratio of compression across the compressor. The ratio of compression is the absolute discharge pressure divided by the absolute suction pressure. A higher ratio of compression requires more stages for compression. Staging is typically required because the gas needs to be cooled between stages to avoid excessive discharge temperatures. In other typical cases, staging is required to avoid overloading the compressor frame or to increase mass flow and compression efficiency.

One or more natural gas wells normally provide the suction gas pressure to a gas gathering compressor. The discharge from the compressor exits into a transmission line that for the purposes of this discussion can be considered to be at a constant pressure, although it can vary. The well pressure diminishes with time as gas is extracted, so more stages of compression are required as the well is depleted. Also, as the well is depleted and the suction pressure drops, the power requirement is typically less for the compressor, so the compressor is underutilized. The compressor then requires larger cylinders to utilize the full capacity of the driver.

In order to maintain the maximum power loading and provide more stages to accommodate the higher pressure ratio, the original compressor package has to be removed and a new compressor package configured with more stages and larger cylinders has to be installed and commissioned at the site. In an ideal situation, the compressor that is removed from the site is relocated to another well that has the same compression requirements as the previous gas well before it was depleted. In many cases, the compressor is decommissioned or misapplied because the cylinder configuration does not match the compression needs.

It can be surmised from the preceding that many different sizes of cylinders and numerous compressor packages are required to meet the compression requirements for natural gas wells. One or two variable bore cylinders that can cover the majority of applications would greatly benefit the gas compression industry and improve utilization of the equipment.

The present invention allows for varying the quantity of valves, as application conditions change, to control fixed clearance volume. Further, the invention provides integral ports in the head(s) with a variable quantity of ports to match the quantity of valves used, and allows the user to vary the size and geometry of the ports to minimize clearance volume and to provide for acceptable flow losses as required for the application.

The present invention also provides a head with a separable annular shaped port ring [32, 34] with a variable quantity of ports to match the quantity of valves used, and allows the user to vary the size and geometry of the ports as required to minimize clearance volume and to provide for acceptable flow losses as required for the application. This removable port ring [34] can simplify field changes for the crank end head (cylinder does not need to be removed from the frame) and a complete head does not need to be changed (only a piece of the head needs to be changed which lowers inventory costs). Further, as an alternative to a one piece, annular shaped port ring design, the one piece port ring [32, 34] can be substituted with a segmented annular ring design consisting of a set of multiple annular sectors. This can provide for individual, removable port inserts in lieu of a one piece, annular shaped removable port ring, as a more economical alternative. The shape of the inserts would not be limited to annular sectors. Also, in another such embodiment, the head end and crank end head do not necessarily need to utilize the port ring(s) in the heads. The liner contains all of the porting geometry, and extends into a recess in the head end and crank end heads. The liner can thus use a variable quantity of ports to match the quantity of valves used. This alternative may not be as flexible, but may be lower in cost. Furthermore, another embodiment incorporates and integrates either one or both port rings [32, 34] into the cylinder liner [28] so that the port rings are eliminated and the port ring features become features of the liner. An extension of the previous embodiment integrates the crank end head [26] and either one or both port rings [32, 34] into the cylinder liner [28].

Rather than having liner port flow areas that are essentially constant and do not vary with changing bore sizes, the present invention provides for a variable quantity of ports to match the quantity of valves used, and varying the size and geometry of the ports as required to minimize clearance volume and to provide for acceptable flow losses as required for the application.

Because typical cylinders constructed according to prior art do not “tune” or “time” the opening of the cylinder body or cylinder liner port(s) to coincide with the opening of the valves, the present invention provides a rectangular liner port which aligns with the profile of the piston face when the discharge or suction valve opens. The geometry of the port is wider than the traditional elliptical port in the transverse direction, which minimizes pressure losses and reduces clearance volume. The rectangular port can also be included in the cylinder body, if needed. Port tuning can also be used with the suction ports if the need arises. A wider, optimized rectangular suction port can also be used to expose the full port area at the time the suction valve opens to avoid masking from the piston.

Circular ports in the cylinder body of the present invention provide flow area improvement to the portion of the valve masked by the piston, as compared to the traditional elliptical ports. Also, the position of the valves or ports can be biased away from the face of the head to reduce masking by the piston.

The present invention enables the cylinder liner bore to be reduced to a practical limit before clearance volumes become too large and/or flow velocities become too high for acceptable operation. Suction valve extension insert/adapter(s) [82] and discharge valve extension insert/adapter(s) [84] can be added (see FIGS. 5-7) to position the valve closer to the compression chamber bore, which reduces the clearance volume contributed by the porting. The suction valve extension insert/adapter(s) [82] and discharge valve extension insert/adapter(s) [84] can also be used to adapt a smaller valve to a cylinder without positioning the valve closer to the compression chamber bore. The valve extension inserts may be eliminated and replaced with longer valve retainers if either one or both port rings [32,34] are integrated into the cylinder liner [28] (so that the port rings are eliminated) and the port ring features become features of the liner. This modification provides a suitable sealing surface on the cylinder liner for the valve to seat against. A gasket is interposed between the valve and the cylinder liner. Smaller suction valves [52] and smaller discharge valves [54] are used because the reduced bore size does not require the larger valves that were required for the larger bores. A reduced quantity of valves may also be utilized because the reduced bore size may not require as many valves as were required for the larger bores. The resultant clearance volume provided by this modification is at a value typically associated with cylinders manufactured according to the present art for an equivalent bore. As also described in the first embodiment depicted in FIGS. 2-4, valves can be eliminated as the bore diameter decreases, and the liner ports and head port flow areas can be reduced as required to reduce clearance volume.

The lower 75th percentile range of the smaller bore diameters can be readily converted from high ratio applications to low ratio applications by retaining a full complement of the larger valves and utilizing large ports in the port rings [32,34] and the cylinder liner [28].

Although not the only viable configuration for the present invention, valve pocket chambers [20] are arranged so that the suction valves [52] lie on one side of a vertical plane oriented parallel to and through the axis of the cylinder bore and the discharge valves [54] lie on the other side of the vertical plane oriented parallel to and through the axis of the cylinder bore. This arrangement allows for a shorter cylinder assembly because the axis of valve pocket chambers [20] can be located closer to the axis of the suction and discharge flanges [14,16] on the cylinder body [10] without interfering with the suction and discharge flanges [14,16]. Suction valves [52] and [54] are located at the lowermost valve pocket chamber [20] to eliminate pooling of lubrication oil in the suction plenum [60].

All modifications to the cylinder of the present invention can be accomplished without removing the cylinder from the compressor frame or the process piping or pulsation control vessels from the cylinder and can be accomplished with basic tools and equipment available to mechanics for servicing the cylinder assembly in the field. Although not the only viable configuration for the present invention, valve pocket chambers [22] can be arranged so that the suction valves lie on one side of a horizontal plane oriented parallel to and through the axis of the cylinder bore and the discharge valves lie on the other side of the horizontal plane oriented parallel to and through the axis of the cylinder bore, at the expense of a longer cylinder body.

The suction valve extension insert/adapters(s) [82], the extended suction valve(s) [152], and the valve retainer(s) [148], as well as the discharge valve extension insert/adapters(s) [84], the extended discharge valve(s) [154], and the valve retainer(s) [148] can be designed as “cartridge style” sub-assemblies that enables all three components to be installed or removed as an intact sub-assembly to facilitate installation. Also, the present invention is not limited to the “valve-in-body” design and may be applied to the “valve in head design” previously described. All mathematical permutable combinations that include some feature(s) of the present invention and exclude other feature(s) may be used in the invention as needed to achieve satisfactory performance of the cylinder assembly of the invention described herein.

While the present invention has been illustrated by the description of embodiments and examples thereof, it is not intended to restrict or in any way limit the scope of the appended claims to such detail. Additional advantages and modifications will be readily apparent to those skilled in the art. For example, the invention can be applied to any compressible fluid medium, and can also be applied to single-acting reciprocating cylinders and double-acting cylinders that have been modified to single-acting configuration. The cylinder of the invention is suitable for use in high, medium and low compression ratio applications. Accordingly, departures may be made from the details described above without departing from the scope or spirit of the invention.

What is claimed is:

1. A reciprocating compressor cylinder for admitting gas at a suction inlet and discharging gas at increased pressure from a discharge outlet, the compressor cylinder comprising a body, a liner, at least one cylinder head, head end port rings, crank end port rings, suction valve(s), suction valve plug(s), suction valve extension insert/adapter(s), suction valve retainer(s), discharge valve(s), discharge valve plug(s), discharge valve extension insert/adapter(s), and discharge valve retainer(s), wherein said liner, head end port rings, crank end port rings, valves, valve extension insert/adapters, valve plugs and valve retainers can be installed or removed from the compressor cylinder either as separate components or as intact sub-assemblies.

2. The compressor cylinder of claim 1, wherein the cylinder can be reconfigured with larger or smaller bores in-situ in the field as the compression requirements change by removing, in the following order, the head end cylinder head, the piston assembly, the suction valve retainers, suction valve(s), the suction valve extension insert/adapter(s) the discharge valve retainers, the discharge valves(s), the discharge valve extension insert/adapters(s) and the cylinder liner from the cylinder assembly, thereafter removing the current crank end port rings and replacing them with new crank end port rings possessing the proper port configuration, thereafter removing the head end port rings and replacing them with new head end port rings possessing the proper port configuration, thereafter installing a new cylinder liner, a new piston assembly having a diameter that matches the new cylinder liner, the head end cylinder head, suction valve extension insert/adapter(s), suction valve(s), suction valve plugs, suction valve retainers, discharge valve extension insert/adapters(s), discharge valves(s), discharge valve plugs, and discharge valve retainers in the cylinder assembly as required for the application.

3. The compressor cylinder of claim 1, wherein the cylinder utilizes head end port inserts and crank end port inserts in place of the head end port rings and crank end port rings, respectively.

4. The compressor cylinder of claim 3, wherein the cylinder can be reconfigured with larger or smaller bores in-situ in the field as the compression requirements change by removing, in the following order, the head end cylinder head, the piston assembly, the suction valve retainers, suction valve(s), the suction valve extension insert/adapter(s) the discharge valve retainers, the discharge valves(s), the discharge valve extension insert/adapters(s) and the cylinder liner from the cylinder assembly, thereafter removing the current the crank end port inserts and replacing them with new crank end port inserts possessing the proper port configuration, thereafter removing the head end port inserts and replacing them with new head end port inserts possessing the proper port configuration, thereafter installing a new cylinder liner, a new piston assembly having a diameter that matches the new cylinder liner, the head end cylinder head, suction valve extension insert/adapter(s), suction valve(s), suction valve plugs, suction valve retainers, discharge valve extension insert/adapter(s), discharge valves(s), discharge valve plugs, and discharge valve retainers in the cylinder assembly as required for the application.

5. The compressor cylinder of claim 1, wherein the cylinder utilizes new head end and crank end heads without port rings or port inserts, the proper port configurations being an integral part of the heads.

6. The compressor cylinder of claim 5, wherein the cylinder can be reconfigured with larger or smaller bores in-situ in the field as the compression requirements change by removing, in the following order, the head end cylinder head, the piston assembly, the suction valve retainers, suction valve(s), the suction valve extension insert/adapter(s) the discharge valve retainers, the discharge valves(s), the discharge valve extension insert/adapters(s) and the cylinder liner from the cylinder assembly, thereafter removing the current the crank end head and replacing it with a new crank end head possessing the proper port configuration, thereafter installing a new cylinder liner, a new piston assembly having a diameter that matches the new cylinder liner, a new head end head possessing the proper port configuration, suction valve extension insert/adapter(s), suction valve(s), suction valve plugs, suction valve retainers, discharge valve extension insert/adapter(s), discharge valves(s), discharge valve plugs and discharge valve retainers in the cylinder assembly as required for the application.

7. The compressor cylinder of claim 1, wherein the cylinder utilizes a new liner with the proper port configurations in place of the head end port rings and crank end port rings, respectively, the port configurations being an integral part of the liner.

8. The compressor cylinder of claim 7, wherein the cylinder can be reconfigured with larger or smaller bores in-situ in the field as the compression requirements change by removing, in the following order, the head end cylinder head, the piston assembly, the suction valve retainers, suction valve(s), the suction valve extension insert/adapter(s) the discharge valve retainers, the discharge valves(s), the discharge valve extension insert/adapters(s) and the cylinder liner from the cylinder assembly, thereafter installing a new cylinder liner possessing the proper port configuration, thereafter installing a new piston assembly having a diameter that matches the new cylinder liner, the head end cylinder head, suction valve extension insert/adapter(s), suction valve(s), suction valve plugs, suction valve retainers, discharge valve extension insert/adapter(s), discharge valves(s), discharge valve plugs, discharge valve retainers, and head end head in the cylinder assembly as required for the application.

9. The compressor cylinder of claim 1, wherein the cylinder utilizes a head end head with an integral liner, in one piece, with the proper port configurations, in place of a separate head, liner and the head end port rings and crank end port rings, respectively, the port configurations being an integral part of the one-piece integral head and liner.

10. The compressor cylinder of claim 9, wherein the cylinder can be reconfigured with larger or smaller bores in-situ in the field as the compression requirements change by removing, in the following order, the head end cylinder head with integral liner, the piston assembly, the suction valve retainers, suction valve(s), the suction valve extension insert/adapter(s) the discharge valve retainers, the discharge valves(s) and the discharge valve extension insert/adapters(s) from the cylinder assembly, thereafter installing a new piston assembly having a diameter that matches the new cylinder liner, a new head end head with integral liner possessing the proper port configuration, suction valve extension insert/adapter(s), suction valve(s), suction valve plugs, suction valve retainers, discharge valve extension insert/adapter(s), discharge valves(s), discharge valve plugs, and discharge valve retainers in the cylinder assembly as required for the application.

11. The compressor cylinder of claim 1, wherein the cylinder utilizes a variable size and/or quantity of valves and valve ports.

12. The compressor cylinder of claim 11, wherein the cylinder can be reconfigured with smaller bores in the field as the compression requirements change by removing one or more suction or discharge valve(s) and valve retainer(s) and replacing each with a new valve having a smaller size, each new valve positioned within a valve extension insert/adapter and retained by a new valve retainer as required for the application.

13. The compressor cylinder of claim 11, wherein the cylinder can be configured with smaller bores in the field as compression requirements change by removing one or more suction or discharge valve(s) and valve retainer(s) and replacing each with a valve plug retained by a valve retainer as required for the application.

14. The compressor cylinder of claim 11, wherein the cylinder can be configured with smaller bores in the field as compression requirements change by removing one or more suction or discharge valve(s) and valve retainer(s) and replacing each with a valve plug having a saddle shape that conforms to the diameter of the cylinder liner bore, retained by a valve retainer as required for the application.

15. The compressor cylinder of claim 11, wherein the cylinder can be configured with smaller bores in the field as compression requirements change by removing the cylinder liner and one or more suction and discharge valve(s) and valve retainer(s) and replacing each with a new valve having a smaller size, each new valve installed after installing a new liner having the appropriate porting and valve seating geometry for the new smaller size valve(s), seated against the liner without using a valve extension insert(s)/adapter(s) and retained by a valve retainer(s) as required for the application.

16. The compressor cylinder of claim 11, wherein the cylinder can be configured with smaller bores in the field as compression requirements change by removing one or more suction or discharge valve(s) and valve retainer(s) installing a new liner having fewer ports so that the unneeded cylinder valve ports are blanked off by the liner.

17. The compressor cylinder of claim 1, wherein the cylinder includes discharge porting that consists of a semicircular port(s) that is merged with and adjacent to a rectangular port(s) machined in the cylinder liner, with such rectangular port designed so that it aligns with the position of the external profile of the piston face at or very close to the end of the compression event when the discharge valve opens.

18. The compressor cylinder of claim 1, wherein the cylinder includes suction porting that consists of a semicircular port(s) that is merged with and adjacent to a rectangular port(s) machined in the cylinder liner, with such rectangular port designed so that it aligns with the position of the external profile of the piston face at or very close to the end of the expansion event when the suction valve opens.

19. The compressor cylinder of claim 1, wherein the cylinder includes circular valve ports in the body to provide an improved flow area to the portion of the valve that is masked by the piston when the piston is at or near the end of its stroke.

20. A method of controlling the fixed clearance volume of the cylinder body of a reciprocating compressor cylinder, the method comprising:
a) providing integral port and valve elements for insertion into the cylinder body, the port and valve elements comprising a body, a liner, at least one cylinder head, head end port ring(s), crank end port ring(s), suction valve(s), suction valve plug(s), suction valve extension insert(s), suction valve retainer(s), discharge valve(s), discharge valve plugs), discharge valve extension insert(s), and discharge valve retainer(s);
b) changing the size and geometry of at least one of the port and valve elements to minimize clearance volume and to provide for acceptable flow losses as required for a particular application; and
c) removing at least one of the port and valve elements to vary the number, size and geometry of the port and valve elements to minimize clearance volume and to provide for acceptable flow losses as required for a particular application.

21. The method of claim 20, wherein head end port inserts and crank end port inserts are used in place of head end port rings and crank end port rings, respectively.

22. The method of claim 20, wherein a new liner with the proper port configurations is used in place of the head end port rings and crank end port rings, respectively, the port configurations being an integral part of the liner.

23. The method of claim 20, wherein the compressor includes discharge porting that consists of a semicircular port(s) that is merged with and adjacent to a rectangular port(s) machined in the cylinder liner, with such rectangular port designed so that it aligns with the position of the external profile of the piston face at or very close to the end of the compression event when the discharge valve opens.

24. The method of claim 20, wherein the compressor includes suction porting that consists of a semicircular port(s) that is merged with and adjacent to a rectangular port(s) machined in the cylinder liner, with such rectangular port designed so that it aligns with the position of the external profile of the piston face at or very close to the end of the expansion event when the suction valve opens.

25. The method of claim 20, wherein the compressor cylinder includes circular valve ports in the body to provide an improved flow area to the portion of the valve that is masked by the piston when the piston is at or near the end of its stroke.

26. A method of quickly and easily removing a valve, valve insert and valve retainer of a compressor from a cylinder body valve pocket as an entire unit or cartridge in a single motion, the method comprising providing integral ports in the cylinder body with a variable quantity and geometry of ports to match the quantity of valves used, thereby allowing the user to vary the number, size and geometry of the ports to minimize clearance volume and to provide for acceptable flow losses as required for a particular application.
